(19) United States
(12) Patent Application Publication
(10) Pub. No.: US 2013/0159087 A1
(43) Pub. Date: Jun. 20, 2013

(54) METHOD AND SYSTEM FOR ENABLING USE OF LOYALTY PROGRAM POINTS AS FORM OF PAYMENT

(71) Applicant: Switchfly, Inc., San Francisco, CA (US)

(72) Inventors: Christopher Boyd, Oakland, CA (US); Ranjani Krishnaswamy, San Francisco, CA (US); Kevin Baughman, Galvaston, TX (US)

(73) Assignee: SWITCHFLY, INC., San Francisco, CA (US)

(21) Appl. No.: 13/648,929

(22) Filed: Oct. 10, 2012

Related U.S. Application Data
(60) Provisional application No. 61/545,410, filed on Oct. 10, 2011.

(51) Int. Cl. G06Q 30/02

(52) U.S. Cl. CPC G06Q 30/0233
USPC 705/14.33

(57) ABSTRACT

A method and system for enabling use of loyalty program points as form of payment. In one preferred embodiment, the method may include the steps of receiving from an e-commerce agent, a request for a loyalty points price along with a transaction information package comprising a cash price and user identification information; sending the user identification information to a loyalty program and requesting user account authentication from the loyalty program; querying the loyalty program for a user information package comprising a cash-to-points conversion factor; calculating a loyalty points price based on the cash price and the cash-to-points conversion factor; sending to the e-commerce agent, the loyalty points price; receiving from the e-commerce agent, confirmation of transaction completion and a number of loyalty points utilized; and sending instructions to the loyalty program to debit from the updated loyalty program points balance the number of loyalty points utilized in the transaction.

### CLAIM OF PRIORITY

The present application claims priority to: U.S. Provisional Patent Application Ser. No. 61/545,410 entitled “Method and System for Payment to a Partnered Vendor with Travel Points” and filed on 10 Oct. 2011, which is incorporated in entirety by this reference.

### TECHNICAL FIELD

This invention relates generally to the field of loyalty programs such as travel rewards programs, and more specifically to a new and useful method and system for enabling use of loyalty program points as form of payment.

### BACKGROUND

Internet technology has revolutionized travel management, providing user-friendly online booking. Many loyalty programs encourage loyalty by awarding loyalty program points to users for purchases with the same supplier, i.e. the supplier of the loyalty program. The users may then redeem these loyalty program points for further travel or other related goods or services. However, present day redemption systems are inefficient and limited in options. Users may only redeem their loyalty program points for goods and services that are directly related to travel—other flights, hotels, tours, rental cars, and the like. Furthermore, loyalty program members are currently limited to a slim catalog when redeeming points for merchandise. They expect, however, the product breadth offered by the biggest retailers, as well as merchandise that is available in high-demand seasons such as the holidays. Thus, there is a need in the field of loyalty programs such as travel rewards programs to create a new and useful method and system for enabling use of loyalty program points as form of payment. This invention provides such a new and useful method and system.

### BRIEF DESCRIPTION OF THE FIGURES

FIGS. 1A and 1B are flowcharts depicting a first and second method for enabling use of loyalty program points as form of payment in accordance with a preferred embodiment;

FIG. 2 is a schematic representation of a price API workflow in accordance with a preferred embodiment;

FIG. 3 is a schematic representation of a profile API workflow in accordance with a preferred embodiment;

FIG. 4 is a schematic representation of a redeem API workflow in accordance with a preferred embodiment;

FIG. 5 is flowchart depicting a method for enabling use of loyalty program points as form of payment in accordance with a alternative preferred embodiment;

FIG. 6 is a schematic representation of a link API workflow in accordance with a preferred embodiment;

FIG. 7 is a schematic representation of a refund API workflow in accordance with a preferred embodiment;

FIG. 8 is a schematic depicting a method for enabling direct to merchant communication and use of loyalty program points as form of payment in accordance with a alternative preferred embodiment;

FIGS. 9-11 are representations of a user interface or browser in accordance with a preferred embodiment;

FIG. 12 is a schematic representation of a method of a preferred embodiment;

FIG. 13 is a schematic flowchart of an example of the method of a preferred embodiment;

FIG. 14 is an example of loyalty programs, e-commerce agents, and vendors that might be linked to the centralized hub of the system of a preferred embodiment;

FIG. 15 is an example of a user interface through which a user might input their account information with a loyalty program;

FIGS. 16 and 17 are schematic flowcharts of an example of the method of a preferred embodiment;

FIG. 18 is an example of a user interface through which a user could select a ratio of points to cash to make a purchase with;

FIG. 19 is a schematic block diagram of a system for enabling use of loyalty program points as form of payment in accordance with a preferred embodiment; and

FIG. 20 is a flowchart depicting an exemplary implementation of a method for enabling use of loyalty program points as form of payment in accordance with a preferred embodiment.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### Methods

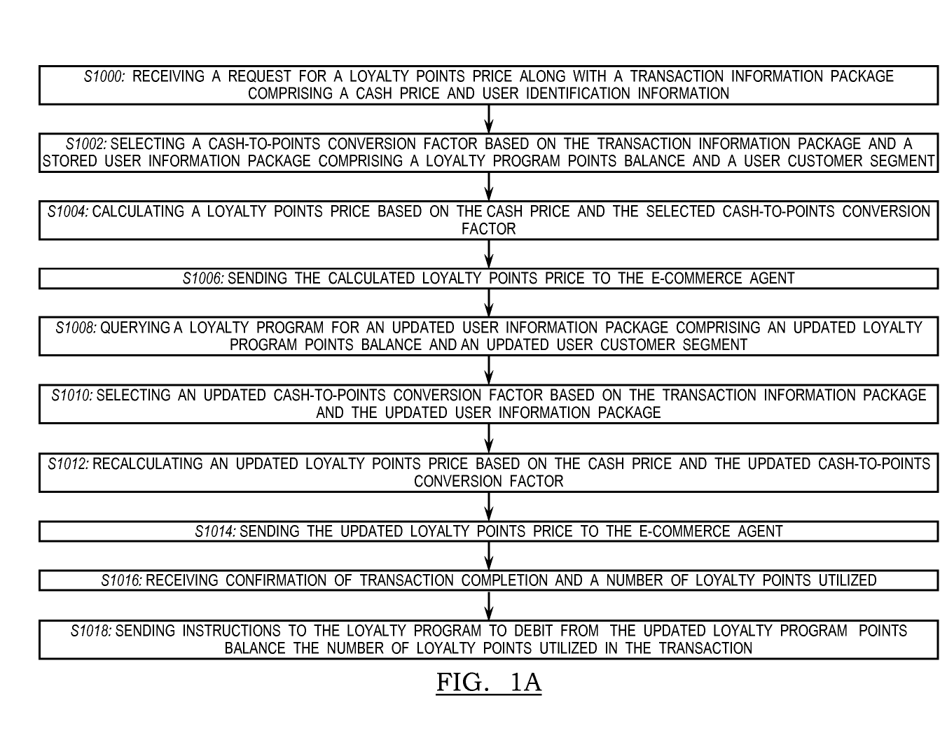

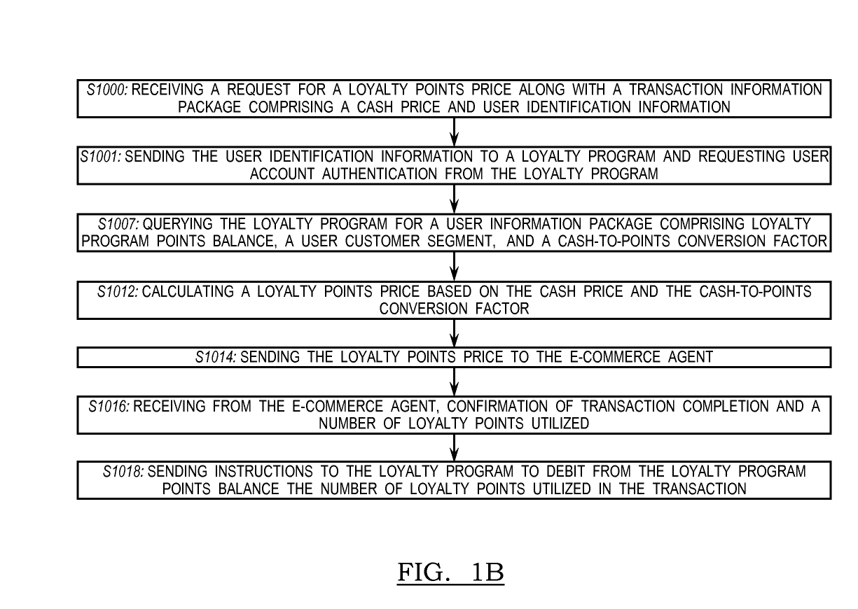

As shown in FIG. 1A, a first method for enabling use of loyalty program points as form of payment may include: receiving through an application programming interface (API), from a first computer associated with an e-commerce agent, a request for a loyalty points price along with a transaction information package comprising a cash price and user identification information in block S1000; selecting, from a conversion factor database, a cash-to-points conversion factor based on the transaction information package and a stored user information package comprising a loyalty program points balance and a user customer segment in block S1002; calculating with a processor a loyalty points price based on the cash price and the selected cash-to-points conversion factor in block S1004; sending, through the API, to the first computer associated with the e-commerce agent, the calculated loyalty points price in block S1006; querying a second computer associated with a loyalty program for an updated user information package comprising an updated loyalty program points balance and an updated user customer segment in block S1008; selecting, from the conversion factor database, an updated cash-to-points conversion factor based on the transaction information package and the updated user information package in block S1010; recalculating an updated loyalty points price based on the cash price and the updated cash-to-points conversion factor in S1012; sending, through the API, to the first computer associated with the e-commerce agent, the updated loyalty points price in block S1014; receiving through the API, from the first computer associated with an e-commerce agent, confirmation of transaction completion and a number of loyalty points utilized in block S1016; and sending instructions to the second computer associated with the loyalty program to debit from the updated loyalty program points balance the number of loyalty points utilized in the transaction in block S1018.

As shown in FIG. 1B, a second method for enabling use of loyalty program points as form of payment may include: receiving through an application programming interface (API), from a first computer associated with an e-commerce agent, a request for a loyalty points price along with a transaction information package comprising a cash price and user identification information in block S1000; sending the user identification information to a second computer associated with a loyalty program and requesting user account authentication from the loyalty program in block S1001; querying a second computer associated with a loyalty program for a user information package comprising loyalty program points balance, a user customer segment, and a cash-to-points conversion factor in block S1007; calculating a loyalty points price based on the cash price and the cash-to-points conversion factor in S1012; sending, through the API, to the first computer associated with the e-commerce agent, the loyalty points price in block S1014; receiving through the API, from the first computer associated with an e-commerce agent, confirmation of transaction completion and a number of loyalty points utilized in block S1016; and sending instructions to the second computer associated with the loyalty program to debit from the loyalty program points balance the number of loyalty points utilized in the transaction in block S1018.

The first and second methods preferably function to allow partnered vendors or payment partners to seamlessly connect to and process redemptions with a specific loyalty program. The loyalty program may be associated with a travel service provider (e.g. airline or hotel loyalty program), a financial service provider (e.g., a bank or credit card points or membership rewards program), a gaming or social network (e.g. Facebook credits or game points), or any suitable kind of loyalty program. The method functions to provide a user with the opportunity to use loyalty program points with partnered vendors that are not necessarily associated with travel. For example, an online merchant, such as Target.com or BestBuy.com, may be a partnered vendor of an airline company, and a software platform will use this method to enable a customer of both the online merchant and the airline company to use their points to purchase a product or service. In some embodiments, a merchant (online or otherwise) may be both a partnered vendor and a payment partner. Alternatively, a merchant may interact with the systems and methods described herein and connect to and process redemptions with a specific loyalty program through a payment partner. A payment partner may be any suitable e-commerce agent such as PayPal, Isis mobile wallet, Google Wallet, and the like. An e-commerce agent is any software platform linked to a user's financial accounts that enables them to access, pay with, and deposit to those accounts through the software platform. The information is preferably relayed via the TCP/IP model but may alternatively be relayed through near-field communication, any protocol from the Internet protocol suite, or any other suitable method of relaying information from a client to a remote server.

In some embodiments, the method preferably functions to enable a user to pay for portions of their vacation, or even their entire vacation, with loyalty program points, including not only the airfare and hotel stay, but food, clothing, souvenirs, cab or hired vehicle fare, and other travel-associated or non-travel associated purchases. Alternatively, the method may enable a user to pay for any other suitable type of purchase with loyalty program points.

As shown in FIG. 1, the method may include block S1000, which recites receiving through an application programming interface (API), from a first computer associated with an e-commerce agent, a request for a loyalty points price along with a transaction information package comprising a cash price and user identification information. Block S1000 preferably functions to receive information regarding the transaction that the user wishes complete with loyalty program points and functions to receive information about the user themselves. Furthermore, Block S1000 functions to initiate the method of enabling use of loyalty program points as form of payment upon the receipt of the request for the loyalty points price. The transaction information package may include any suitable information about the transaction that the user may wish to complete with loyalty program points. For example the transaction information package may include the cash price of the product or service that the user wishes to purchase. Furthermore, the transaction information package may include information about the merchant from which the purchase is being made, information about the product or service to be purchased, purchase history of the user, and any other suitable information. In some embodiments, user identification information may include a user's name; loyalty program member identification information such as username, password, and member ID; payment partner identification information such as username and password; and any other suitable information.

Block S1000 may be performed through an API. Block S1000 may be performed through a single API, or may be performed through a combination of multiple APIs. In one preferred embodiment, block S1000 may be performed through a Price Request/Response API. The Price Request/Response API may be a request and response webservice API. This API may be initiated when a payment partner or e-commerce agent wishes to determine the price of the product or service to be purchased in a points based price based on a user's identification information and their relationship with a loyalty program. A user's identification information may include name, current loyalty program points balance, current loyalty program customer segment (e.g. “gold”, “platinum”, “premium”, etc.), years as a member of the loyalty program, loyalty contract, user's cash-to-points conversion factor, and any other suitable identifying information. The payment partner or e-commerce agent may perform a points price request through a Price Request/Response API to determine the points price and to be able to display that points price (at checkout, for example) to the user.

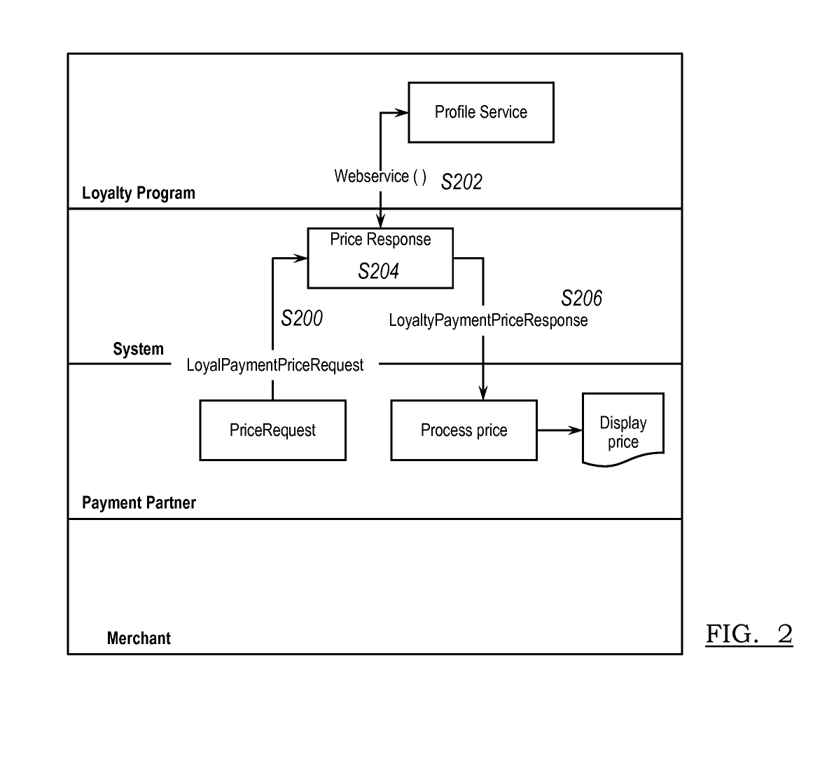

As shown in FIG. 2, the Price Request/Response API workflow may include the steps of receiving from an e-commerce agent or payment partner a request for a loyalty points price along with a transaction information package comprising a cash price and user identification information in block S200; querying a loyalty program for a user information package comprising a user customer segment and a cash-to-points conversion factor in block S202; calculating a loyalty points price based on the cash price and the cash-to-points conversion factor in block S204; and responding to the e-commerce agent with the loyalty points price in block S206. In an alternative embodiment of the Price Request/Response API, the API may be run directly with a merchant (online or otherwise) rather than going through a payment partner.

As shown in FIG. 2, the Price Request/Response API may include block S200, which recites receiving from an e-commerce agent or payment partner a request for a loyalty points price along with a transaction information package comprising a cash price and user identification information. Block S200 preferably functions to receive information regarding the transaction that the user wishes complete with loyalty program points and functions to receive information about the user themselves. Furthermore, Block S200 functions to initiate the Price Request/Response API. Information regarding the transaction may include a description of the item being priced, a merchant code or ID number, the purchase item price amount (i.e. cash price), currency code (e.g. USD), and any other suitable information about the transaction. Block S200 may also function to receive information about the user. Information about the user may include a user or member token (such as a token associated to a member ID), a user account identifier (such as a unique value for a specific user), and any other suitable user information. Block S200 may also receive a session token from the payment partner. The payment partner session token may be used to maintain the link request session of the user with the payment partner, the controller of the system, and/or the loyalty program.

As shown in FIG. 2, the Price Request/Response API may include block S202, which recites querying a loyalty program for a user information package comprising a user customer segment and a cash-to-points conversion factor. Block S202 preferably functions to reach out to the loyalty program to determine information about the user and their relationship with the loyalty program. For example, the user information package may include a user customer segment and a cash-to-points conversion factor. Additionally, the user information package received from the loyalty program may include the number of points the user has available for purchases, their total balance of loyalty program points, the cash value of the number of points the user has available for purchases, the cash value of their total balance of loyalty program points (alternatively, these numbers may be calculated from the cash-to-points conversion factor), a marketing message for the user, and any other suitable information. Additionally, the user information package may also include information about the loyalty program contract in general and/or specific to the user.

In some embodiments, the conversion factor may depend on the user's customer segment. For example if the user is a premium customer (for example, they have a large balance of points, they recently purchased an expensive ticket, they have been a member for several years, they have a credit card associated with the loyalty program, etc.) they may receive a more favorable conversion factor than a user in a lower customer segment. A more favorable conversion factor may be one that provides a higher cash value for the same number of points.

In some embodiments, if the user's number of points the user has available for purchases is not high enough to purchase the desired product or service, block S202 may perform the additional step of performing additional checks to determine if the user qualifies to purchase the item with a combination of loyalty program points and cash. For example a user may only have an available balance of 500 loyalty points. The cash price of the $50 item may be 5,000 points. If the user is qualified to use a combination of points and cash, they may be able to utilize their balance of 500 points in addition to spending $45 to meet the balance. In block S202, if the user qualifies for this feature, the loyalty program may return the number of points that the member will need to redeem as well as the cash equivalent amount to meet the balance. Alternatively, these numbers may be calculated by the systems and methods described herein.

As shown in FIG. 2, the Price Request/Response API may include block S204, which recites calculating a loyalty points price based on the cash price and the cash-to-points conversion factor. Block S204 preferably functions to convert the cash price of a product from cash currency into a loyalty program points price. The points price is preferably calculated based on the cash-to-points conversion factor. For example, a cash-to-points conversion factor of 100 (100 points/$) applied to a cash price of $50 results in a points price of 5,000. In this example the cash price is multiplied by the cash-to-points conversion factor. In some embodiments, the conversion factor may be stored as a points-to-cash conversion factor. For example, a points-to-cash conversion factor may be 0.01 ($0.01/pt). The cash price of $50 may be divided by this conversion factor to provide a points price of 5,000. In alternative embodiments, the cash-to-points (or points-to-cash) conversion factor may be applied to the cash price in any suitable manner.

As shown in FIG. 2, the Price Request/Response API may include block S206, which recites responding to the e-commerce agent with the loyalty points price in block S206. Block S206 preferably functions to return the loyalty points price to the payment partner per their request. Block S206 may additionally function to return any suitable user information received from the loyalty program including a user customer segment, the number of points the user has available for purchases, their total balance of loyalty program points, the cash value of the number of points the user has available for purchases, the cash value of their total balance of loyalty program points, the marketing message for the user, and any other suitable information. This information may then be displayed by the payment partner.

Returning to FIG. 1, the method may include block S1002, which recites selecting, from a conversion factor database, a cash-to-points conversion factor based on the transaction information package and a stored user information package comprising a loyalty program points balance and a user customer segment. Block S1002 functions to select the appropriate cash-to-points conversion factor. In a preferred method the cash-to-points conversion factor will be selected based on the transaction information package received from the e-commerce agent and a user information package. As described above, the transaction information package may include the cash price of the product or service that the user wishes to purchase. Furthermore, the transaction information package may include information about the merchant from which the purchase is being made, information about the product or service to be purchased, purchase history of the user, and any other suitable transaction information. The user information package preferably includes a loyalty program points balance and a user customer segment. In some embodiments, the user information package may further include any other suitable information about the user and their relationship with the loyalty program. For example, the user information package may include a cash-to-points conversion factor (rather than this being calculated by the method or system). Additionally, the user information package may include the number of points the user has available for purchases (which may be different than their total balance of loyalty program points), the cash value of the number of points the user has available for purchases, the cash value of their total balance of loyalty program points (alternatively, as described, these numbers may be calculated from the cash-to-points conversion factor), a marketing message for the user, and any other suitable information. In a preferred method, this user information package is stored and may be updated as necessary. The step of selecting, from a conversion factor database, a cash-to-points conversion factor based on the transaction information package and a stored such that it may be returned upon request at a faster rate. As described below, the stored user information package may be updated periodically and/or upon request.

Block S1002 preferably functions to select an applicable cash-to-points conversion factor from a conversion factor database, such as through a search query or table lookup. The conversion factor database is preferably configured to store various tiers of conversion factors, and the tiers can be organized based on one or more parameters. The applicable cash-to-points conversion factor can be based on parameters such as the cash price, such that the value of each loyalty program point varies depending on the cash price of the inventory item. The pricing factor can additionally or alternatively vary with any suitable parameter, such as member segment or demographic (e.g., dependent on loyalty program status or how long the user has been a member of the loyalty program, age, gender, user location), transaction history of the member (e.g., user historically seems more willing than an average user to pay more for luxury items) or product type or other attribute of the inventory item. In some embodiments, the conversion factor may depend on the user's customer segment. For example if the user is a premium customer (for example, they have a large balance of points, they recently purchased an expensive ticket, they have been a member for several years, they have a credit card associated with the loyalty program, etc.) they may receive a more favorable conversion factor than a user in a lower customer segment. A more favorable conversion factor may be one that provides a higher cash value for the same number of points. Alternatively, the applicable pricing factor can be constant or based on an algorithm that calculates an applicable pricing factor.

As shown in FIG. 1, the preferred method may include block S1004, which recites calculating with a processor a loyalty points price based on the cash price and the selected cash-to-points conversion factor. Block S1004 preferably functions to transform the cash price to a loyalty program points price using the cash-to-points conversion factor. As described above, in reference to Block S204, the points price is preferably calculated based on the cash-to-points conversion factor. For example, a cash-to-points conversion factor of 100 (100 points/$) applied to a cash price of $50 results in a points price of 5,000. In this example the cash price is multiplied by the cash-to-points conversion factor. In some embodiments, the conversion factor may be stored as a points-to-cash conversion factor. For example, a points-to-cash conversion factor may be 0.01 ($0.01/pt). The cash price of $50 may be divided by this conversion factor to provide a points price of 5,000. In alternative embodiments, the cash-to-points (or points-to-cash) conversion factor may be applied to the cash price in any suitable manner.

As shown in FIG. 1, the preferred method may include block S1006, which recites sending, through the API, to the first computer associated with the e-commerce agent, the calculated loyalty points price. Block S1006 preferably functions to return the loyalty points price to the payment partner per their request. Block S206 may additionally function to return any suitable user information from the stored user information package. In a preferred embodiment, the user information may be tagged or labeled as “stored information” rather that “recently updated information”. For example, the stored loyalty program points balance and the stored user customer segment may be returned along with the information of when the data were last received from the loyalty program. For example, a time stamp may be sent with the information such that the statement “Last updated 6 days ago” may appear with the presentation of the stored user information. The stored user information may also include the number of points the user has available for purchases, the cash value of the number of points the user has available for purchases, the cash value of their total balance of loyalty program points, the marketing message for the user, and any other suitable information. This information may then be displayed by the payment partner.

As shown in FIG. 1, the preferred method may include block S1008, which recites querying a second computer associated with a loyalty program for an updated user information package comprising an updated loyalty program points balance and an updated user customer segment. In some embodiments, this step may be performed as soon as the request for a loyalty points price is received in block S1000. In other words, block S1008 may be performed while at least one of the steps of Blocks S1002 (selecting a conversion factor), S1004 (calculating a points price), and S1006 (sending the points price) are performed. By sending an initial points price to an e-commerce agent based on stored information, the method may respond to the request for the points price as quickly as possible. At the same time, the method may request updated information from the loyalty program and/or user loyalty program account to verify the initial points price offered before the transaction is completed. This allows the method to be performed more efficiently and allows the method to meet specified response times. For example, a service level agreement (SLA) may specify a response time criteria to be met by the method or system. For example, the response may be desired in one second or less. Conventional loyalty programs do not have the infrastructure and methods to meet such demanding response times.

Block S1008 preferably functions to reach out to the loyalty program to determine updated and/or current information about the user and their relationship with the loyalty program. For example, the user information package may an updated loyalty program points balance and an updated user customer segment. Additionally, the updated user information package received from the loyalty program may include the cash-to-points conversion factor, the number of points the user has available for purchases, their total balance of loyalty program points, the cash value of the number of points the user has available for purchases, the cash value of their total balance of loyalty program points (alternatively, these number may be calculated from the cash-to-points conversion factor), a marketing message for the user, and any other suitable information. Additionally, the user information package may also include information about the loyalty program contract in general and/or specific to the user.

This updated user information received by block S1008 may then be stored, in cache for example, and may be utilized in the future. For example, this information may then become the stored user information package used in selecting, from a conversion factor database, a cash-to-points conversion factor based on the transaction information package and a stored user information package comprising a loyalty program points balance and a user customer segment in block S1002.

In some alternative embodiments, the cache (i.e. the stored user information package) may be updated later in the method. For example, the cache may not be updated until the user confirms the purchase of the item and the points are to be redeemed. In this embodiment, the method may utilize redemption thresholds to determine whether to authorize the sale based on the stored or cached data rather than the real time data. In some embodiments, the thresholds may be configurable by the loyalty program, or may be automatically updated based on the user's customer segment for example. In some embodiments, the loyalty program may be allowed or may have the capability to limit the number of points or the number of transactions per period of time. Again, the thresholds may be configurable by the loyalty program, or may be automatically updated based on the user's customer segment for example.

In some embodiments, the cache (i.e. the stored user information package) may be updated automatically as soon as a link is established between a merchant and/or payment partner and the system and/or loyalty program.

Generally speaking, the cache may be managed in any suitable fashion such that it may balance speed and user experience against security and fraud protection. In some embodiments, the systems and methods may utilize existing services to harvest cache. In some embodiments, the systems and methods described herein may refresh or update cache using an exponential backoff algorithm with a cap of “n” days for example. Alternatively, any other suitable algorithm may be utilized. In some embodiments, as described above, the cache may be automatically updated when the user is shopping or booking reservations with their loyalty program points. In some embodiments, the systems and methods described herein may provide rate limiting. The rate limiting may be provided, based on customer segment for example, with priority ordering. In some embodiments, the systems and methods described herein may provide response time based throttling. This may be utilized to avoid overwhelming the host system or server. In some embodiments, each of these features, or a combination thereof, may be customized, tuned, or otherwise optimized by a system operator and/or the loyalty program partners based on their customer preferences for example. In some embodiments, the data storage and handling may be done so according to PCI level 1 compliance standards or any other suitable industry standards.

Returning to the first and second preferred methods, block S1008 may be performed through an API. Block S1008 may be performed through a single API, or may be performed through a combination of multiple APIs. In one preferred embodiment, block S1008 may be performed through a Profile Request/Response API. The Profile Request/Response API may be a request and response webservice API. This API may be initiated when a payment partner or e-commerce agent determines that user information and their relationship with the loyalty program is needed.

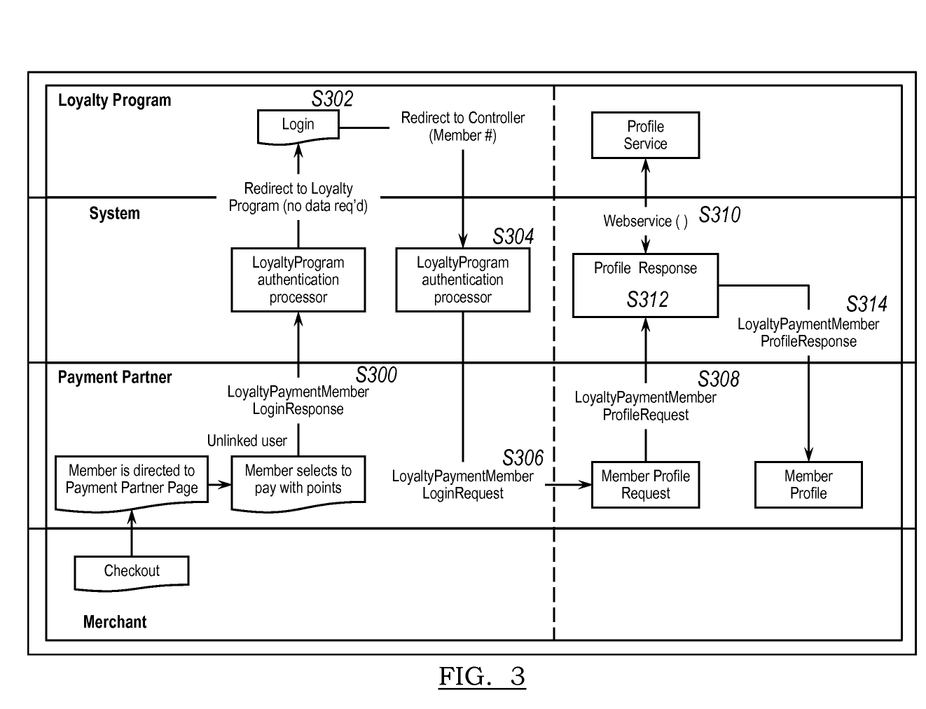

As shown in FIG. 3, the Profile Request/Response API workflow may include the steps of receiving from an e-commerce agent or payment partner a request for a user's loyalty program profile information along with user identification information in block S308; querying a loyalty program for the user's loyalty program profile information in block S310; receiving the user's loyalty program profile information in block S312; and responding to the e-commerce agent with the user's loyalty program profile information in block S314. In an alternative embodiment of the Profile Request/Response API, the API may be run directly with a merchant (online or otherwise) rather than going through a payment partner.

As shown in FIG. 3, the Profile Request/Response API may include block S308, which recites of receiving from an e-commerce agent or payment partner a request for a user's loyalty program profile information along with user identification information. Block S300 preferably functions to receive identifying information about a user. Furthermore, Block S308 functions to initiate the Profile Request/Response API. Information about the user may include a user first name, last name, a user or member token (such as a token associated to a member ID), a user account identifier (such as a unique value for a specific user), and any other suitable user information. Block S308 may also receive a session token from the payment partner. The payment partner session token may be used to maintain the link request session of the user with the payment partner, the controller of the system, and/or the loyalty program.

As shown in FIG. 3, the Profile Request/Response API may include block S310, which recites querying a loyalty program for the user's loyalty program profile information. Block S310 preferably functions to reach out to the loyalty program to determine information about the user and their relationship with the loyalty program. For example, the user information package may include a user first name, last name, a membership ID or an obfuscated membership ID (only the last 4 digits show), a user customer segment and a cash-to-points conversion factor. Additionally, the user information package received from the loyalty program may include the number of points the user has available for purchases, their total balance of loyalty program points, the cash value of the number of points the user has available for purchases, the cash value of their total balance of loyalty program points (alternatively, these numbers may be calculated from the cash-to-points conversion factor), a marketing message for the user, and any other suitable information. Additionally, the user information package may also include information about the loyalty program contract in general and/or specific to the user.

As shown in FIG. 3, the Profile Request/Response API may include block S312, which recites receiving the user's loyalty program profile information. Block S312 preferably functions to receive, from the loyalty program, the user information listed above. As shown in FIG. 3, the Profile Request/Response API may include block S314, which recites responding to the e-commerce agent with the user's loyalty program profile information. Block S314 preferably functions to return the loyalty program profile information to the payment partner per their request. Block S314 may additionally function to return any suitable user information received from the loyalty program including a user customer segment, the number of points the user has available for purchases, their total balance of loyalty program points, the cash value of the number of points the user has available for purchases, the cash value of their total balance of loyalty program points, the marketing message for the user, a status code (such as an operation status code that can be user for a payment partner translation), a status message or a transaction message, and any other suitable information. This information may then be displayed by the payment partner.

Returning to FIG. 1, the preferred method may include blocks S1010, S1012, and S1014 which recite selecting, from the conversion factor database, an updated cash-to-points conversion factor based on the transaction information package and the updated user information package in block S1010; recalculating an updated loyalty points price based on the cash price and the updated cash-to-points conversion factor in S1012; sending, through the API, to the first computer associated with the e-commerce agent, the updated loyalty points price in block S1014. These blocks are similar to the blocks S1002 (selecting a conversion factor), S1004 (calculating a points price), and S1006 (sending the points price); however, they are performed utilizing the updated user information package received from the loyalty program in block S1008. In some embodiments, the updated conversion factor selected in block S1010 may be the same as the conversion factor selected in block S1002. For example, the user's customer segment, point balance, or other pertinent information may not have changed substantially enough to change the conversion factor. Alternatively, in some embodiments, the updated conversion factor selected may be different from the initial conversion factor. For example, a user's customer segment may have been upgraded since their information was last updated. In this example, the method may therefore select a more favorable conversion factor and therefore return a lower points price. In some embodiments, the updated conversion factor may be received from the loyalty program rather than selected from the conversion factor database. For example, the updated cash-to-points conversion factor may be included in the updated user information package from the loyalty program as described above. Therefore, in some embodiments, the method may not need to perform, or may skip, block S1010 of selecting the conversion factor.

As shown in FIG. 1, the preferred method may include block S1016, which recites receiving through the API, from the first computer associated with an e-commerce agent, confirmation of transaction completion and a number of loyalty points utilized. Block S1016 preferably functions to receive from the e-commerce agent an indication that the transaction has been completed, and that the user has used a number of loyalty points to complete the transaction.

Block S1016 may be performed through an API. Block S1016 may be performed through a single API, or may be performed through a combination of multiple APIs. In one preferred embodiment, block S1016 may be performed through a Redeem Request/Response API. The Redeem Request/Response API may be a request and response webservice API. This API may be initiated when user or member wishes to use and/or redeem their loyalty program points to purchase a product.

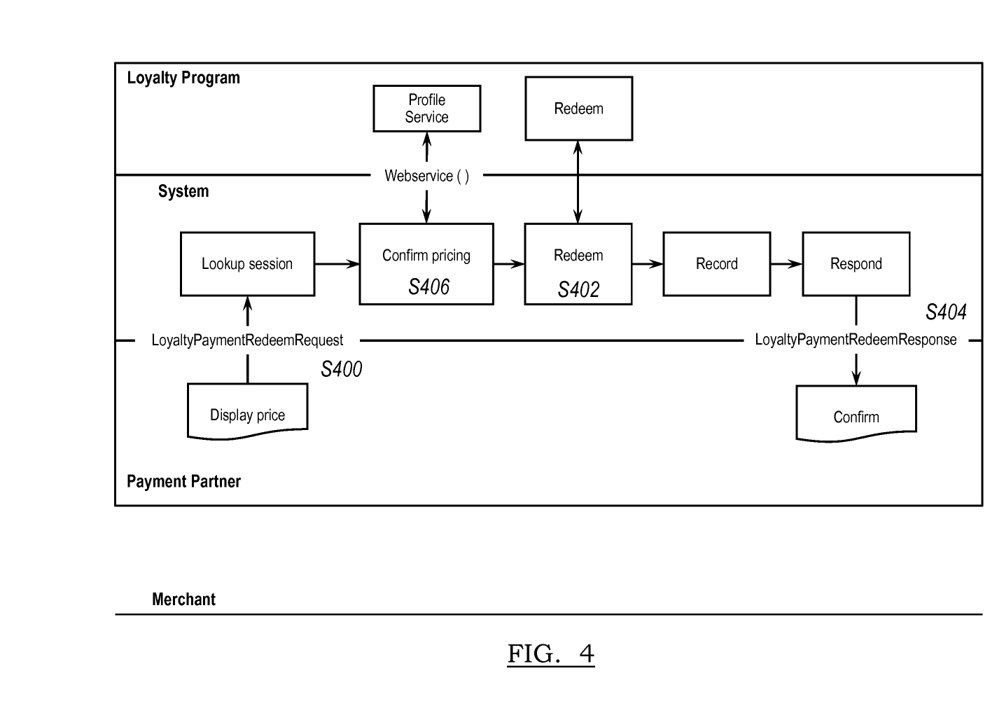

As shown in FIG. 4, the Redeem Request/Response API workflow may include the steps of receiving from an e-commerce agent or payment partner a confirmation of transaction completion and a number of loyalty points utilized in block S400; sending instructions to the loyalty program to redeem the number of loyalty points utilized in the transaction from the user's loyalty program account in block S402; and responding to the e-commerce agent with confirmation that the points have been redeemed from the loyalty program in block S404. In an alternative embodiment of the Redeem Request/Response API, the API may be run directly with a merchant (online or otherwise) rather than going through a payment partner.

As shown in FIG. 4, the Redeem Request/Response API may include block S400, which recites receiving from an e-commerce agent or payment partner a confirmation of transaction completion and a number of loyalty points utilized. Block S400 preferably functions to receive information regarding the transaction that the user has completed with loyalty program points and, in some embodiments, may function to receive information about the user themselves. Furthermore, Block S400 functions to initiate the Redeem Request/Response API. Information regarding the transaction may include a description of the item being purchased, a merchant code or ID number, the purchase item price amount (i.e. points price and/or cash), the number of points paid (may be different from the full points price), the cash value of the number of points paid (may be different from the full cash price), and any other suitable information about the transaction. Block S400 may also function to receive information about the user. Information about the user may include a user or member token (such as a token associated to a member ID), a user account identifier (such as a unique value for a specific user), currency code (e.g. USD), and any other suitable user information. Block S400 may also receive a session token from the payment partner. The payment partner session token may be used to maintain the link request session of the user with the payment partner, the controller of the system, and/or the loyalty program.

As shown in FIG. 4, the Redeem Request/Response API may include block S402, which recites sending instructions to the loyalty program to redeem the number of loyalty points utilized in the transaction from the user's loyalty program account. Block S402 preferably functions to reach out to the loyalty program and to send instruction for the loyalty program to debit from the user's loyalty program points balance the number of loyalty points utilized in the transaction. In an alternative embodiment, block S402 may debit the number of point utilized directly from the loyalty program.

As shown in FIG. 4, the Redeem Request/Response API may include block S404, which recites responding to the e-commerce agent with confirmation that the points have been redeemed from the loyalty program. Block S404 preferably functions to return a confirmation to the payment partner that the points have been redeemed per their request. Block S404 may additionally function to return any suitable information about the transaction and/or the redemption of the points. For example, Block S404 may respond with an order ID (to be utilized in service calls like refunds, for example), a transaction ID, status code, status message, and any other suitable information.

In some embodiments, the Redeem Request/Response API workflow may further include the step of confirming the transaction price by querying a loyalty program for a user information package comprising a user customer segment and a cash-to-points conversion factor in block S406 as shown in FIG. 4. Block S406 preferably functions to reach out to the loyalty program to determine information about the user and their relationship with the loyalty program to verify that the points price paid such that the correct number of points may be redeemed from their account. For example, the user information package requested may include a user customer segment and a cash-to-points conversion factor. Additionally, the user information package received from the loyalty program may include the number of points the user has available for purchases, their total balance of loyalty program points, the cash value of the number of points the user has available for purchases, the cash value of their total balance of loyalty program points (alternatively, these numbers may be calculated from the cash-to-points conversion factor), a marketing message for the user, and any other suitable information. Additionally, the user information package may also include information about the loyalty program contract in general and/or specific to the user.

In some embodiments, the conversion factor may depend on the user's customer segment. For example if the user is a premium customer (for example, they have a large balance of points, they recently purchased an expensive ticket, they have been a member for several years, they have a credit card associated with the loyalty program, etc.) they may receive a more favorable conversion factor than a user in a lower customer segment. A more favorable conversion factor may be one that provides a higher cash value for the same number of points.

Block S406 may further include the step of calculating a loyalty points price based on the cash price and the cash-to-points conversion factor. Block S406 preferably functions to convert the cash price of a product from cash currency into a loyalty program points price. The points price is preferably calculated based on the cash-to-points conversion factor. For example, a cash-to-points conversion factor of 100 (100 points/$) applied to a cash price of $50 results in a points price of 5,000. In this example the cash price is multiplied by the cash-to-points conversion factor. In some embodiments, the conversion factor may be stored as a points-to-cash conversion factor. For example, a points-to-cash conversion factor may be 0.01 ($0.01/pt). The cash price of $50 may be divided by this conversion factor to provide a points price of 5,000. In alternative embodiments, the cash-to-points (or points-to-cash) conversion factor may be applied to the cash price in any suitable manner.

Returning to FIG. 1, the preferred method may include block S1018, which recites sending instructions to the second computer associated with the loyalty program to debit from the updated loyalty program points balance the number of loyalty points utilized in the transaction. Block S1018 preferably functions to reach out to the loyalty program and to send instruction for the loyalty program to debit from the user's loyalty program points balance the number of loyalty points utilized in the transaction. In an alternative embodiment, block S402 may debit the number of point utilized directly from the loyalty program. As described above, block S1018 may be performed through an API. In some embodiments, the method may be performed through a single API, such as the Redeem API described above, or may be performed through a combination of multiple APIs.

In some embodiments, the method, as shown in FIG. 1, may be performed through an API. In some embodiments, the method may be performed through a single API, or may be performed through a combination of multiple APIs. For example, blocks S1000, S1004, S1006, S1008, S1012, and S1014 may be performed through a Price Request/Response API as described above in reference to FIG. 2. Furthermore, as described above, block S1008 may be performed through a Profile Request/Response API as described above in reference to FIG. 3. Additionally, blocks S1016 and S1018 may be performed through a Redeem Request/Response API as described above in reference to FIG. 4.

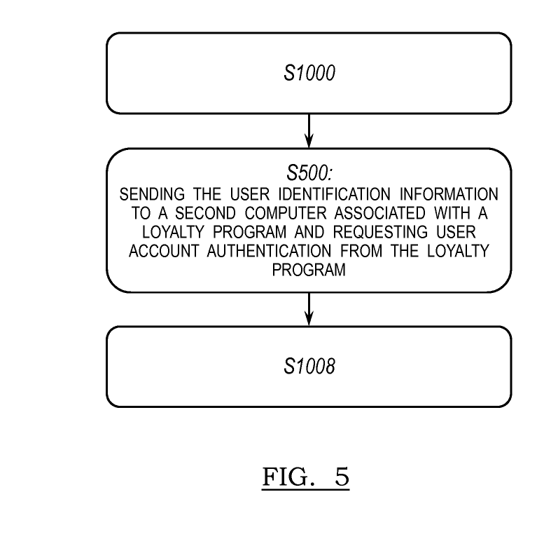

In some embodiments, as shown in FIG. 5, the method may further include the step of sending the user identification information to a second computer associated with a loyalty program and requesting user account authentication from the loyalty program in block S500. In some embodiments, block S500 may be performed at any point after block S1000 of receiving a request for a loyalty points price. In some embodiments, block S500 may be performed before, or during, block S1008 of querying a loyalty program for an updated user information package. Block S500 functions to authenticate a user with a loyalty program. In some embodiments, user identification information may include a user's name; loyalty program member identification information such as username, password, and member ID; payment partner identification information such as username and password; and any other suitable information.

Block S500 may be performed through an API. Block S500 may be performed through a single API, or may be performed through a combination of multiple APIs. In one preferred embodiment, block S500 may be performed through a Login Request/Response API. The Login Request/Response API may be a request and response webservice API. This API may be initiated when a payment partner or e-commerce agent determines that a user is required to authenticate with the loyalty program.

As shown in FIG. 3, the Login Request/Response API workflow may include the steps of receiving from an e-commerce agent or payment partner a request for a loyalty program authentication in block S300; redirecting the authentication request to the loyalty program in block S302; receiving from the loyalty program authentication confirmation in block S304; and responding to the e-commerce agent with the authentication confirmation in block S306. In an alternative embodiment of the Login Request/Response API, the API may be run directly with a merchant (online or otherwise) rather than going through a payment partner.

As shown in FIG. 3, the Login Request/Response API may include block S300, which recites receiving from an e-commerce agent or payment partner a request for a loyalty program authentication. Block S300 preferably functions to receive a request for a loyalty program authentication from a payment partner. Furthermore, Block S300 functions to initiate the Login Request/Response API. In some embodiments, Block S300 may function to receive user information along with the request for authentication. Information about the user may include a user or member token (such as a token associated to a member ID), a user account identifier (such as a unique value for a specific user), and any other suitable user information. Block S300 may also receive a session token from the payment partner. The payment partner session token may be used to maintain the link request session of the user with the payment partner, the controller of the system, and/or the loyalty program. Block S300 may also receive a payment partner security token, a loyalty program code, a payment partner code, and any other suitable information to request and/or facilitate authentication with a loyalty program.

In some embodiments, block S300 may function to receive information regarding the transaction that the user wishes complete with loyalty program points and may function to receive information about the user themselves. Information regarding the transaction may include a description of the item being priced, a merchant code or ID number, the purchase item price amount (i.e. cash price), currency code (e.g. USD), and any other suitable information about the transaction. Block S300 may also function to receive information about the user.

As shown in FIG. 3, the Login Request/Response API may include block S302, which recites redirecting the authentication request to the loyalty program. Block S302 preferably functions to reach out to the loyalty program and to initiate an authentication process. Block S302 may also function to pass on any suitable information from the payment partner for initiating and/or facilitating the authentication process. For example, block S302 may pass on user information along with the request for authentication. Information about the user may include a user or member token (such as a token associated to a member ID), a user account identifier (such as a unique value for a specific user), and any other suitable user information. Block S300 may also pass on a session token from the payment partner. The payment partner session token may be used to maintain the link request session of the user with the payment partner, the controller of the system, and/or the loyalty program. Block S300 may also pass on a payment partner security token, a loyalty program code, a payment partner code, and any other suitable information to request and/or facilitate authentication with a loyalty program.

As shown in FIG. 3, the Login Request/Response API may include block S304, which recites receiving from the loyalty program authentication confirmation. Block S304 preferably functions to receive from the loyalty program an indication that a user has been properly been authenticated into the loyalty program. In some embodiments, block S304 may further function to perform the authentication for the loyalty program.

As shown in FIG. 3, the Login Request/Response API may include block S306, which recites responding to the e-commerce agent with the authentication confirmation. Block S306 preferably functions to return the authentication confirmation to the payment partner per their request. Block S306 may additionally function to return any suitable user information received from the loyalty program including a user customer segment, the number of points the user has available for purchases, their total balance of loyalty program points, the cash value of the number of points the user has available for purchases, the cash value of their total balance of loyalty program points, the marketing message for the user, and any other suitable information. This information may then be displayed by the payment partner. Block S306 may also function to respond to the e-commerce agent with information regarding the authentication process. For example, block S306 may respond to the e-commerce agent or payment partner with a user or member token (such as a token associated to a member ID), an operation status code that may be used for a payment partner translation, and/or a status or transaction message (such as “pass” or “fail”).

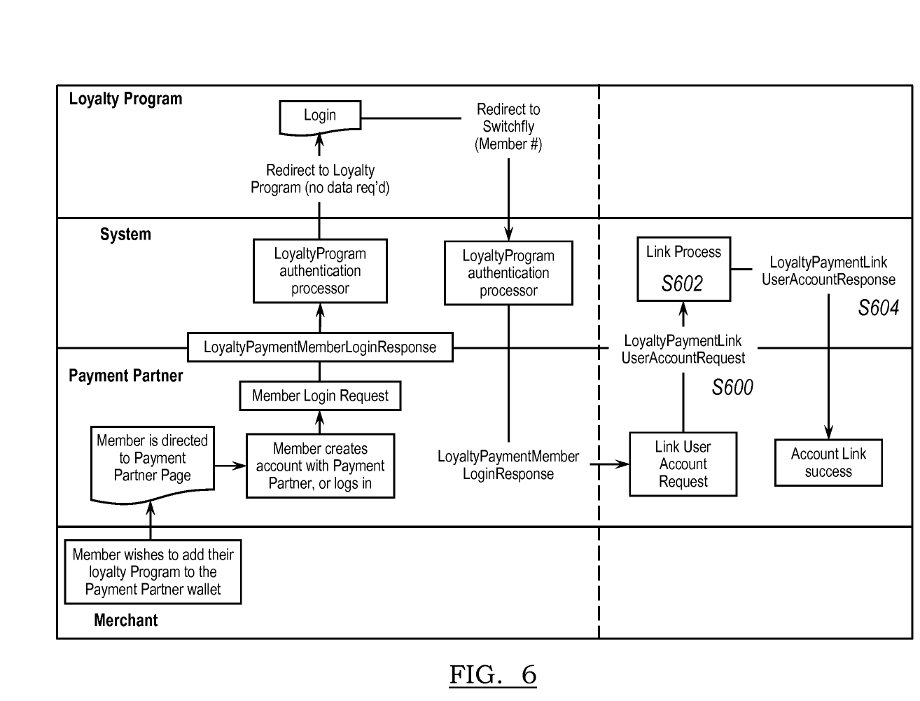

As shown in FIG. 6, in some embodiments, the method may further comprise the step of linking a user's loyalty program account to their payment partner or e-commerce agent account. To complete such a link, a member may login to their payment partner “wallet” and indicate that they wish to link their loyalty program account to the wallet. The payment partner may then initiate the Login Request/Response API described above in reference to FIG. 3 and shown again in FIG. 6. Upon successfully logging in, the payment partner will then immediately initiate a Link Request/Response API as shown in FIG. 6. The Link Request/Response API may be a request and response webservice API that will link (or add) a user's loyalty program account to their payment partner or e-commerce agent account.

As shown in FIG. 6 the Link Request/Response API workflow may include the steps of receiving from an e-commerce agent or payment partner a request for linking a user's loyalty program account to their payment partner account in block S600; performing the link process in block S602; and responding to the e-commerce agent with the link confirmation in block S604. In an alternative embodiment of the Login Request/Response API, the API may be run directly with a merchant (online or otherwise) rather than going through a payment partner.

As shown in FIG. 6, the Link Request/Response API may include block S600, which recites receiving from an e-commerce agent or payment partner a request for linking a user's loyalty program account to their payment partner account. Block Foo functions to initiate the Link Request/Response API. Furthermore, block may function to receive user identification information from the payment partner. Information about the user may include a user or member token (such as a token associated to a member ID), a user account identifier (such as a unique value for a specific user), a user name or identifying email address, and any other suitable user information. Block S200 may also receive a session token from the payment partner. The payment partner session token may be used to maintain the link request session of the user with the payment partner, the controller of the system, and/or the loyalty program.

As shown in FIG. 6, the Link Request/Response API may include block S602, which recites performing the link process. Block S602 functions to link the user's loyalty program account to their payment partner account. As shown in FIG. 6, the Link Request/Response API may include block S604, which recites responding to the e-commerce agent with the link confirmation. Block S604 functions to return a confirmation that the link has been completed to the e-commerce agent or payment partner. The confirmation may include information such as a status code (such as an operation status code that can be used for payment partner translation) and a status message or transaction message (such as “pass” or “fail”).

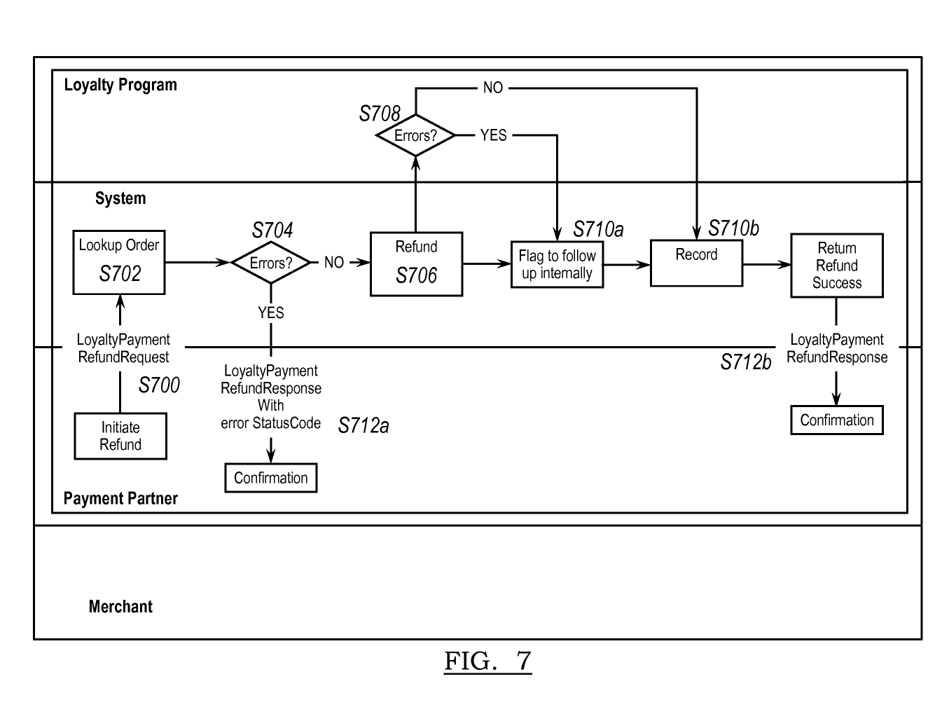

As shown in FIG. 7 in some embodiments, the method may further comprise the step of refunding a number of loyalty points to a user's loyalty program account. To complete such a refund, a user may login to their payment partner account and indicate that they wish to receive a refund for number of loyalty points to their loyalty program account. The payment partner may then initiate a Refund Request/Response API on the user's behalf as shown in FIG. 7. The Refund Request/Response API may be a request and response webservice API that will refund a number of loyalty points to a user's loyalty program account.

As shown in FIG. 7 the Refund Request/Response API workflow may include the steps of receiving a request for a refund of a number of loyalty points to a user's loyalty program account in block S700; identifying the order with which the refund is associated in block S702; checking for errors associated with the order and/or the refund in block S704; confirming the refund and the number of loyalty points in block S706; checking with the loyalty program for errors associated with the refund and the number of loyalty points in block S708; flagging the refund if the loyalty program identified errors associated with the refund and the number of loyalty points in block S710a; recording the refund and the number of loyalty points in block S710b; and responding to the payment partner with confirmation of the refund in block S712b. In some embodiments, if errors are identified in block S704, the method will respond to the payment partner with an error status code in block S712a. In an alternative embodiment of the Login Request/Response API, the API may be run directly with a merchant (online or otherwise) rather than going through a payment partner.

Block S700 may function to receive user information along with the request for the refund. Information about the user may include a user or member token (such as a token associated to a member ID), a user account identifier (such as a unique value for a specific user), and any other suitable user information. Block S200 may also receive an order ID and a reason for refund code. The reason for refund code may include a numerical code that corresponds to a reason. For example, code 50010 may correspond to “The rewards member was charged more than one time for a single transaction”. Code 50020 may correspond to “The rewards member was charged by mistake due to a technical or customer service error by Partner”. Or code 50030 may correspond to “The rewards member was charged for goods or services, but never received the goods or services”. The code may be any suitable code, and the reasons for refund may be any suitable refund reason.

Blocks S712a and S712b may function to respond to the payment partner with a confirmation of the refund. Transaction information may also be returned with the confirmation of the refund. For example, the method may return a transaction ID (such as a new ID that is specific to the refund), a status code, and a status message (such as “success” or “fail”). The status code and/or status message may return an error message or code corresponding to an error message. For example, status code 10000 may correspond to “system error”. Code 20080 may correspond to “refund has already been processed”. Code 20150 may correspond to “user has exceeded time allowed on the site. User will need to re-authenticate”. The code may be any suitable code, and the reasons for error may be any suitable refund reason.

As described herein, the methods may be performed through an API. In some embodiments, the methods may be performed through a single API, or may be performed through a combination of multiple APIs. Consider the use scenario where a user wishes to link their loyalty program account with a payment partner wallet. This may be performed through a Login API and a Link API as described above in reference to FIG. 6. Consider the use scenario where a user wishes to purchase a product using their loyalty program points and they have linked their loyalty program account with their payment partner account. The user may log in to their payment partner wallet and access their loyalty program account. This scenario may be performed through a Price API as described above in reference to FIG. 2, and a Redeem API (if the user wishes to proceed with the purchase) as described above in reference to FIG. 4. The scenario may also optionally utilize a Profile API as described above in reference to FIG. 3. Consider the use scenario of a user who wishes to purchase a product using points. However, that user does not have a payment partner account or wished to bypass login to their payment partner account. The user may not have linked their loyalty program account with their payment partner wallet. This scenario may be performed through a Login API and Profile API as described in FIG. 3, a Price API as described above in reference to FIG. 2, and a Redeem API (if the user wishes to proceed with the purchase) as described above in reference to FIG. 4. In this scenario, if the user then wishes to link their loyalty program account with their payment partner wallet after completing an unlinked or guest checkout, this may be performed through a Login API and a Link API as described above in reference to FIG. 6. In the use scenario where the user wished to receive a refund or return an item, the payment partner may initiate a Refund API on the user's behalf, as described above in reference to FIG. 7. And finally, consider the use scenario where a user wishes to unlink their account from the loyalty program transaction history page. This may be performed by performing an unlink call back to the payment partner.

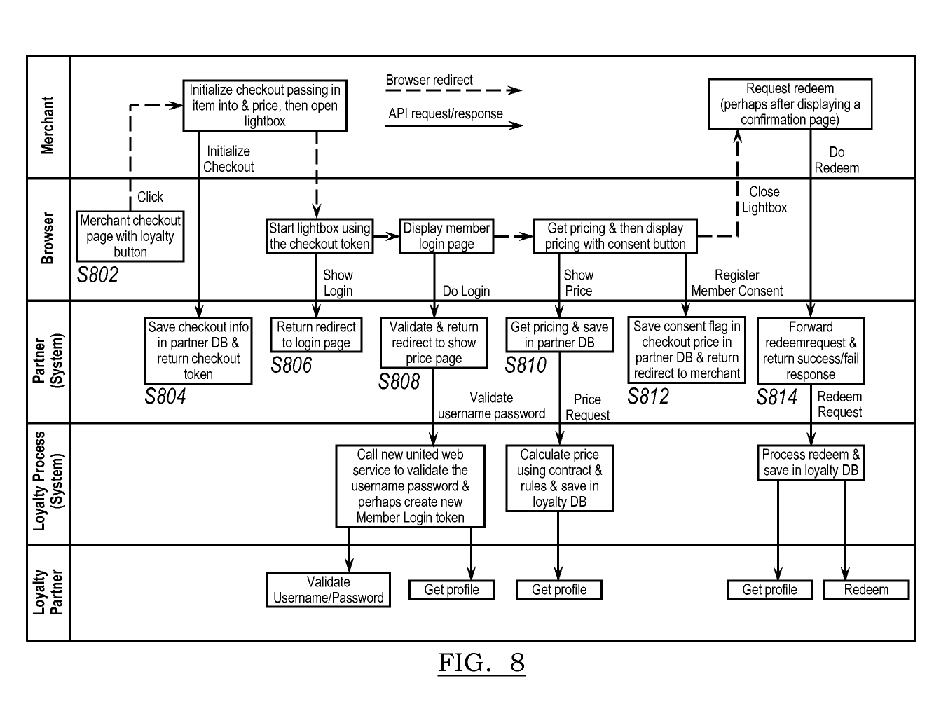

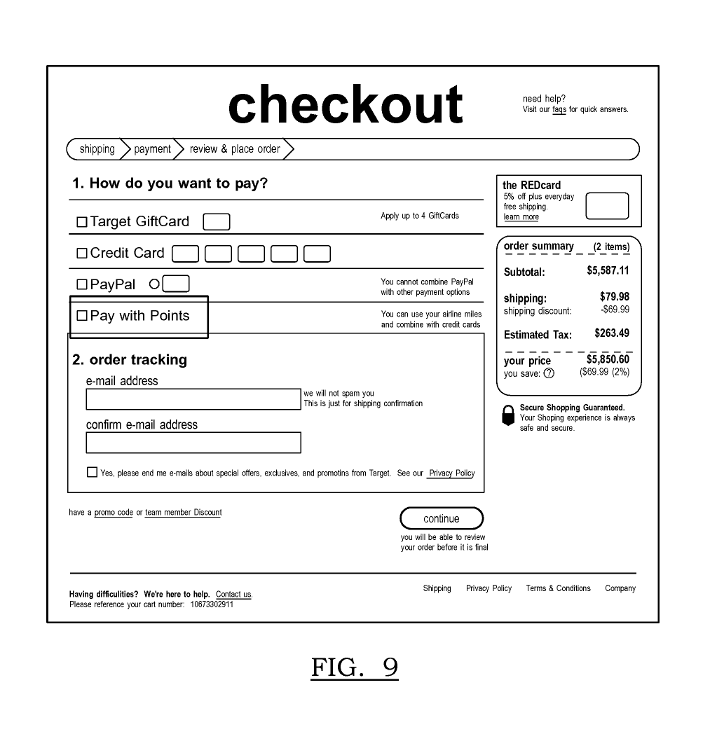

In some embodiments, as shown in FIGS. 8-11, the methods may be performed by communicating directly with a merchant (online or otherwise), rather than working through a payment partner. As shown in FIG. 8, a user navigates to a merchant checkout page on a browser or other user interface in block S802. The user makes a “Pay with Points” selection. As shown in FIG. 9, the “Pay with Points” option may be displayed on a merchant branded checkout page. In this example, the merchant is TARGET. The merchant may alternatively be any other suitable merchant (online or otherwise). Returning to FIG. 8, the merchant initiates an Initialize Checkout Request API and the system receives a request for a checkout from the merchant in block S804. Block S804 functions to initiate the Initialize Checkout Request/Response API, to save the checkout information in a merchant partner database, and to return a checkout token to the merchant. The checkout token may be used in all subsequent server/server and browser/server requests. The merchant is then able to embed the “Pay with Points” button and the systems javascript library on their checkout page, as shown in FIG. 9. In some embodiments, block S804 functions to receive a authentication key. This key may be utilized to map an incoming request to a given merchant and/or to map to a specific application (e.g. checkout flow). In some embodiments, a merchant may be given multiple user keys. In an alternative embodiment, block S804 may also receive a secret key and password from the merchant to verify that the merchant is actually who they say they are. Alternatively any other suitable authentication and/or fraud protection system may be utilized such as a 2 or 3-legged OAuth.

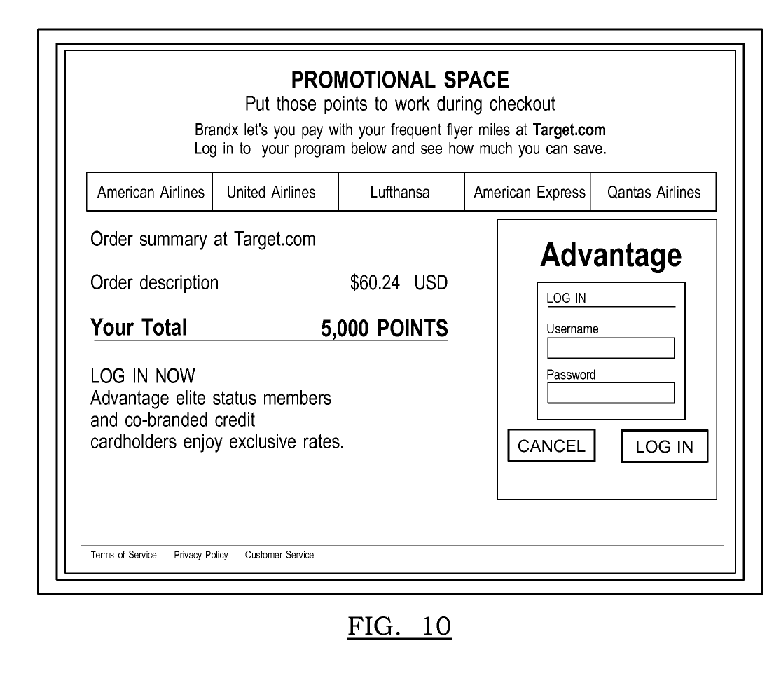

Additionally, when the user makes the selection to pay with points, a “trigger lightbox” command is invoked and the system lightbox is displayed on the merchant branded browser page (e.g. the checkout page). As shown in FIG. 10, the system login may be displayed in the lightbox. The lightbox is displayed using the checkout token received from the system. In general, creating a lightbox includes setting up a storage structure followed by defining the web pages behavior for display of the picture or special message. Block S806 functions to return the login page to the merchant branded browser for display.

The user may then log into the system login screen as shown in FIG. 10. In this example, the login screen may be branded for a specific loyalty program such as American Airlines' loyalty program of AAdvantage. Alternatively, the login may be loyalty program agnostic, or may display any other suitable loyalty program or a plurality of loyalty programs. For example, as shown in FIG. 10, the browser may display a plurality of tabs, wherein each tab displays a different loyalty program. As the user clicks through each tab, they may log into each loyalty program and/or may view their initial points price for each loyalty program. As shown in FIG. 10, the login screen may also display a cash price (e.g. $60.24), a product description from the merchant, an order description from the merchant, and an initial points price based on the conversion factor received at last login (e.g. 5,000 points). In some embodiments, the initial points price may be out of date, and may require the user to log into the loyalty program to receive updated information.

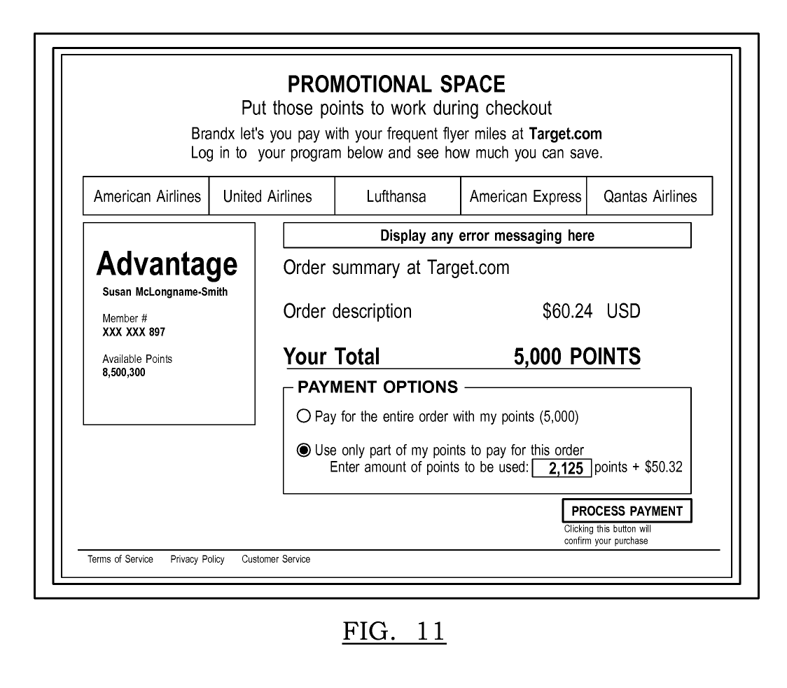

Returning to FIG. 8, the method may further include the step of validating the user login information and validating and/or receiving the user profile information in block S808. In some embodiments, block S808 may be performed in a similar fashion to the Login Request/Response API and the Profile Request/Response API as described in reference to FIG. 3. For example, block S808 may further include the steps of redirecting the authentication request to the loyalty program; receiving from the loyalty program authentication confirmation and/or user profile information; and sending the authentication confirmation to be displayed on the browser along with any suitable profile information. The lightbox may then be redirected to display the show price page, as shown in FIG. 11.

In this example, the show price screen, as shown in FIG. 11, may be branded for a specific loyalty program such as American Airlines' loyalty program of AAdvantage. Alternatively, the login may be loyalty program agnostic, or may display any other suitable loyalty program or a plurality of loyalty programs. For example, as shown in FIG. 11, the browser may display a plurality of tabs, wherein each tab displays a different loyalty program. As the user clicks through each tab, they may see their points price, etc. for each loyalty program. As shown in FIG. 11, the show price screen may also display a cash price (e.g. $60.24), a product description from the merchant, an order description from the merchant, and an updated points price based on the conversion factor received just received at login (e.g. 5,000 points).

Returning to FIG. 8, the method may further include the step of receiving pricing information in block S810. In some embodiments, block S810 may be performed in a similar fashion to the Price Request/Response API as described in reference to FIG. 2. For example block S810 may further include the steps of receiving from a merchant a request for a loyalty points price along with a cash price; querying a loyalty program for a cash-to-points conversion factor; calculating a loyalty points price based on the cash price and the cash-to-points conversion factor; and responding to the merchant (via the merchant branded browser) with the loyalty points price.

As shown in FIG. 8, the user may then review the pricing information and may consent to pay with points. In some embodiments, as shown in FIG. 11, the user may be given the option of paying for the entire order with points, or paying for a portion of the order with points, and may enter the number of points to be used. Upon consenting to pay with points and selecting the process payment button, the system receives a Register Member Consent Request from the merchant in block S812. This may also function to initiate the closing of the lightbox.

As shown in FIG. 8, the method may further include the step of sending the request for loyalty points redemption to the loyalty program in block S814. In some embodiments, block S814 may be performed in a similar fashion to the Redeem Request/Response API as described in reference to FIG. 4. For example, block S814 may further include the steps of receiving from a merchant a confirmation of transaction completion and a number of loyalty points utilized; sending instructions to the loyalty program to redeem the number of loyalty points utilized in the transaction from the user's loyalty program account; and responding to the merchant with confirmation that the points have been redeemed from the loyalty program.

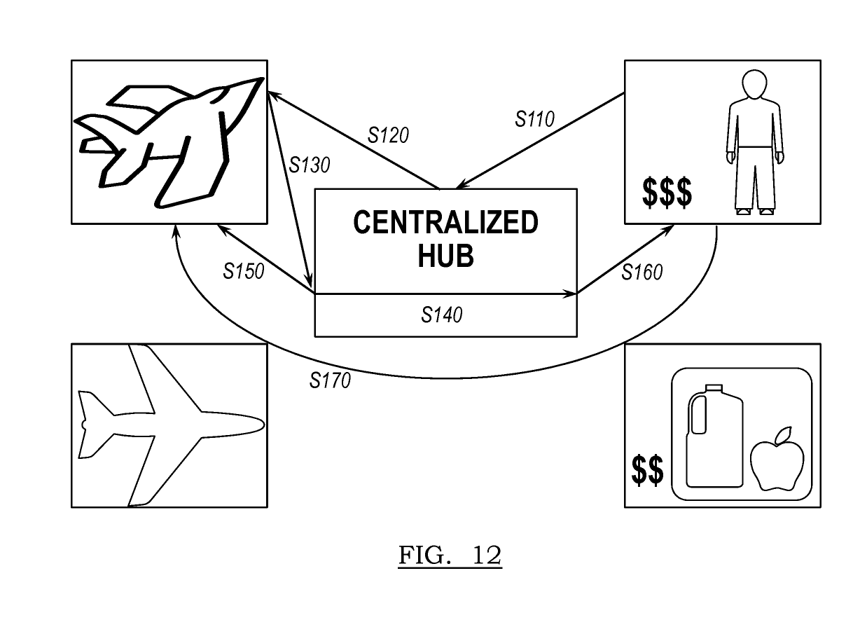

As shown in FIG. 12, a method for payment to a partnered vendor with loyalty program points through a centralized hub of an alternative preferred embodiment includes the steps of receiving, from the partnered vendor of a loyalty program, a user request for a purchase S110; determining, based on user information and partnered vendor information, if there is at least one loyalty program with which the user has an account S120; retrieving a cash-to-points conversion factor from the at least one loyalty program S130, calculating, based on the conversion factor and a cash price of the purchase, a number of loyalty program points for the purchase S140, querying the at least one loyalty program for a number of loyalty program points in the user's account S150, providing the user with an option to pay with loyalty program points if he or she has enough to pay for the purchase S160, and debiting, if the user selects the option to pay with loyalty program points, the number of loyalty program points from the user's loyalty program account S170. The loyalty program may be associated with a travel service provider (e.g. airline or hotel loyalty program), a financial service provider (e.g., a bank or credit card points or membership rewards program), a gaming or social network (e.g. Facebook credits or game points), or any suitable kind of loyalty program. The method functions to provide a user with the opportunity to use loyalty program points with multiple vendors that are not necessarily associated with travel. For example, a coffee shop may be a partnered vendor of an airline company, and a software platform will use this method to enable a client of both the coffee shop and the airline company to use their points to buy a cup of coffee. The method preferably functions to enable a user to pay for their entire vacation with loyalty program points, including not only the airfare and hotel stay, but also food and other travel-associated purchases. Alternatively, the method may enable a user to pay for any other suitable type of purchase. Alternatively, as shown in the user interface of FIG. 9, the purchase may be made over the Internet. The system operator of an embodiment of the system preferably manages a hub that links multiple partnered vendors with multiple loyalty programs.

Information is preferably relayed between the vendor or merchant, the loyalty program, and the centralized hub. Alternatively, information may also be relayed between these and an “e-commerce agent” such as PayPal, Isis mobile wallet, Google Wallet, and the like. An e-commerce agent is any software platform linked to a user's financial accounts that enables them to access, pay with, and deposit to those accounts through the software platform. The information is preferably relayed via the TCP/IP model but may alternatively be relayed through near-field communication, any protocol from the Internet protocol suite, or any other suitable method of relaying information from a client to a remote server.

In some embodiments, a user will have preferably pre-registered their loyalty accounts with a system operator of the central hub. Alternatively, the user may have preferably pre-registered their e-commerce agent accounts with a system operator. For example, a user may have set up their PayPal account to link to the centralized hub of the system. Alternatively, the registration is automated. In some embodiments, the user may register their accounts during or after a transaction and payment with loyalty points is completed.

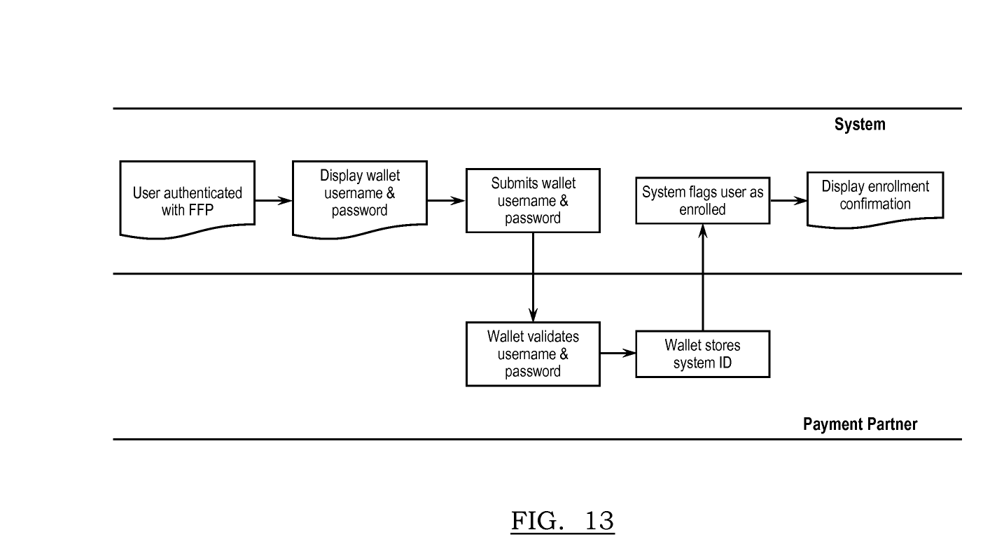

As shown in FIG. 13, in one preferred embodiment, the user may wish to link their system (or central hub) account to their payment partner wallet account (e.g. paypal account). Alternatively, the user may wish to link their loyalty program account to their payment partner wallet. The loyalty program account may be linked directly to their payment wallet account, or it may be linked through the central hub of the system described herein. For example, while the user is logged into the central hub, they may enter their payment wallet account information such as username and password. The user may be authenticated with the central hub with FFP, or in any other suitable fashion. Once the user enters their payment wallet information, the central hub may submit the information to the payment wallet for verification. The central hub may also send a code or ID along with the submission, such that the payment wallet may store the code or ID for future interactions with this user and with the central hub of the system described herein. Once the payment wallet has verified that the accounts have been linked, the central hub may flag the user as a linked user or as an enrolled user, and then may display to the user confirmation of their enrollment.

In an alternative embodiment, user account registration may be performed as follows, using a American Airlines AAdvantage account as an exemplary loyalty program and PayPal as an exemplary e-commerce agent (variations include communication between other loyalty programs and e-commerce agent): a user logs into their loyalty program account such as AAdvantage; the user then opts to link their loyalty program account with either the central hub of the system described herein and/or with a payment partner wallet; the loyalty program may then invoke a secure hub widget which seamlessly authenticates the user on the hub system via Single Sign On, for example; the hub widget may then display a field for the user to enter their payment wallet account information, such as paypal username and password; the user may then enter their information and submit the same; once received, the hub widget may submit the username and password to paypal via a secure webservice, where it is validated and confirmed, as described above in reference to FIG. 13.

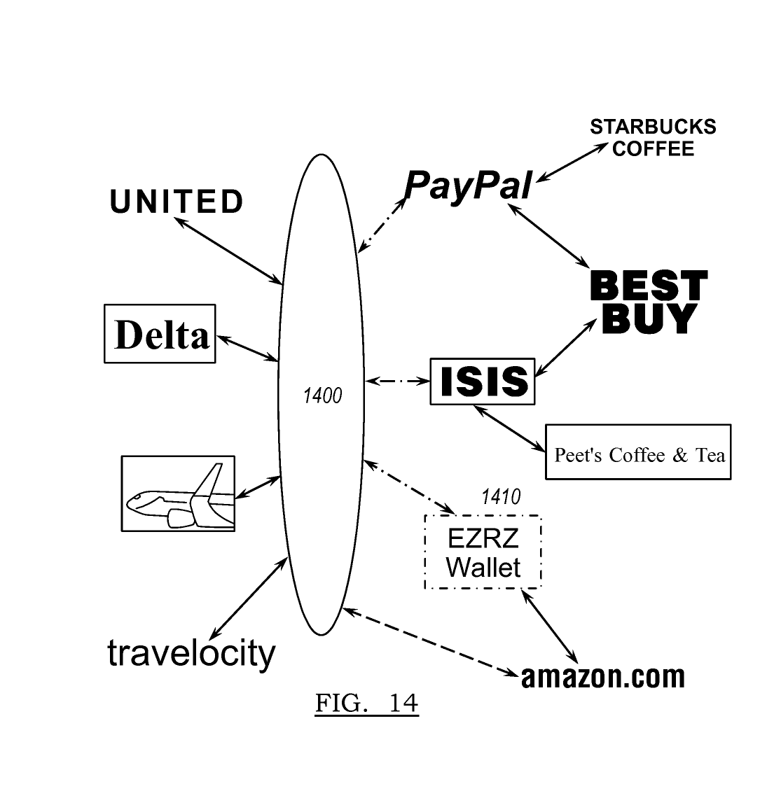

As exemplified in FIG. 14, the centralized hub 1400 may link to a set of loyalty programs (United, Delta, Alaska, Travelocity, in the example as shown), and may also link to a set of vendors (Starbucks, Best Buy, Peets, Amazon, in the example as shown), or a set of e-commerce agents (paypal, ISIS, a payment wallet connected to the central hub 1410, in the example as shown) which are, in turn, linked to one or more of the vendors. Alternatively, the centralized hub 1400 may link to multiple loyalty programs but one particular e-commerce agent and/or partnered vendor. Alternatively, the centralized hub may be linked directly to a particular vendor or set of vendors. These links preferably result in secure connections, enabling fraud protection. The payment process in this method preferably occurs in real-time. Alternatively, there may be a significant time delay between the initial query and the actual processing of the payment.

Returning to FIG. 12, step S110, which includes receiving, from the partnered vendor of a loyalty program, a user request for a purchase, functions to initiate a payment transaction that gives the user an option to pay with points. In a preferred embodiment, the user may be presented with the option to request a purchase at least partially using points (or other loyalty program credits). The partnered vendor of the loyalty program may be any type of vendor—a vendor of drinks, a vendor of food, a vendor of consumer electronics, a vendor of clothes, a vendor of hotel stays, and the like. Likewise, the loyalty program may be an airline company, a travel agency, a hotel chain, a rental car company, and the like. The purchase of the user may be initiated in person at a physical location of the vendor, on the user's mobile phone, on the user's computer, or on any other suitable purchasing platform.

The request for the purchase preferably relays the identity of the preferred vendor to the centralized hub. For example, the request may relay the information that the user is making a purchase at Starbucks, which is a partnered vendor of a loyalty program (for example, American Airlines) with whom the user has an account. The method will enable the user to pay for the coffee with loyalty program points from that loyalty program, thus enabling the rewarding of loyalty to the loyalty program with everyday purchases. Alternatively, the request for the purchase may relay a stock-keeping unit (SKU) of a product that is being bought, thus enabling the rewarding of loyalty based on brand type rather than vendor type. Alternatively, both a vendor identity and an SKU are relayed. For example, the request may relay the information that is user is making a purchase of a Sony product at Best Buy, which is a partnered vendor of a loyalty program (for example, United Airlines) that the user has an account with. The method will enable the user to pay for the Sony product with loyalty program points from that loyalty program, thus enabling the rewarding of loyalty to the particular brand (in this case, Sony).

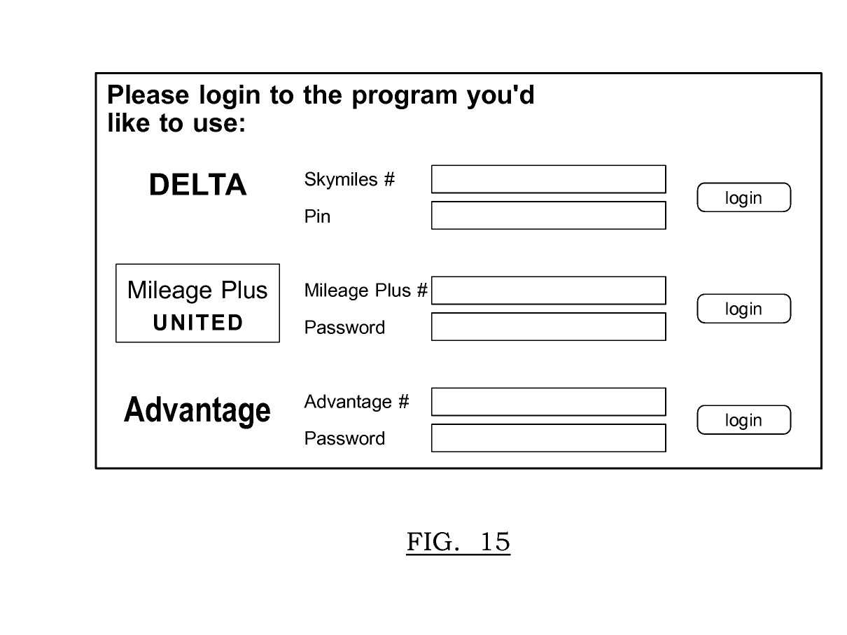

The step of receiving from the partnered vendor of a loyalty program, a request for a purchase of a user, preferably involves the receiving of one or more identifying parameters of the user, the cash price of their purchase, and the identity of the partnered vendor. As mentioned above, the step may also involve the receiving of an SKU and any other suitable piece of information related to the purchase. An identifying parameter may be a frequent flier number, a username, a password, metadata, an email address, a cell phone number, an IP address, an electronic serial number, a birthday, a mail address, a social security number, a driver's license number, a photograph, a video, an identifying piece of clipart, an answer to a secret question, a financial instrument (e.g., a credit card), an account number, a biometric datum, or any other suitable piece of identifying data. A frequent flier number may be collected via a user interface, as shown in FIG. 15. In some embodiments, each of the loyalty programs may show up on a single page, or alternatively, the browser may display a plurality of tabs, wherein each tab displays a different loyalty program.

The connection between a partnered vendor and a loyalty program, between a loyalty program and an e-commerce agent, and/or between an e-commerce agent and a partnered vendor may be established by the same software platform running the systems and methods described herein. The software platform may include a partner management portal enabling loyalty programs to partner with specific vendors. For example, an representative of United Airlines may log onto a website linked to the system and initiate a partnership with a vendor such as Best Buy or Starbucks. This preferably happens before the method is run.

Step 120, which includes determining, based on user information and partnered vendor information, if there is at least one loyalty program with which the user has an account, functions to check if the user has the option of paying for the purchase with loyalty program points. In a preferred embodiment, the request for the purchase of the user is relayed to an e-commerce agent such as PayPal, Isis mobile wallet, Google Wallet, and the like. In a preferred embodiment, the centralized hub is linked to a set of e-commerce agents, at least one of which is linked to a set of partnered vendors. For example, as shown in FIG. 14, the centralized hub is linked to Google Wallet, PayPal, and ISIS, each of which is connected to its own set of partnered vendors. Alternatively, as shown in FIG. 14, the centralized hub may be linked to a single e-commerce agent, which is linked to a set of partnered vendors.

In an alternative embodiment and as shown in component 1410 of FIG. 14, the platform on which the method is run also functions as an e-commerce agent. In other words, the system operator of the platform running the method may also develop a component of the platform that performs the same function as an e-commerce agent would. In this embodiment, the centralized hub is linked to a set of partnered vendors.

The step S120 of determining, based on user information and partnered vendor information, if there is at least one loyalty program with which the user has an account, preferably involves two sub-steps of (1) searching for a loyalty program of the partnered vendor, and (2) receiving information about whether or not the user making the purchase has an account with that loyalty program. The second step of receiving information about whether or not the user has an account with the loyalty program preferably involves searching through a database of users. In a preferred embodiment, this database belongs to a loyalty program. In an alternative embodiment, this database resides on a platform of the system operator.

Step S130, which includes retrieving a cash-to-points conversion factor from the at least one loyalty program, functions to assist in determining the number of loyalty program points that is equivalent to a cash price of a product. In a preferred embodiment, the conversion factor is the same for all users. In an alternative embodiment, the conversion factor will vary depending on the user's identity. For example, if the loyalty program has information indicating that the user is a premier member, the user may receive a lower conversion factor of cash to loyalty program points, i.e. a more favorable conversion factor. Similarly, conversion factors may vary depending on what “tier” the user belongs to; the loyalty program may have, for example, a premium tier. In a preferred embodiment, the conversion factor of cash to loyalty program points is stored in a database belonging to the loyalty program. In an alternative embodiment, the conversion factor is stored in a database belonging to the system operator.

Step S140, which includes calculating, based on the conversion factor and a cash price of the purchase, a number of loyalty program points for the purchase, functions to determine the number of loyalty program points to display to the user. The calculation is preferably performed via the multiplication of a cash price of the purchase by the conversion factor of cash to loyalty program points. Alternatively, the calculation may be performed via any other suitable mathematical scheme or formula. In a preferred embodiment, the same mathematical scheme or formula is employed for all users. In an alternative embodiment, the mathematical scheme or formula used varies depending on an identifying parameter of the user. For example, premium members may have the conversion factor multiplied by the cash price and always have a fixed amount of points subtracted (perhaps to reward them for having bought a premium membership).

The step of calculating, based on the conversion factor and a price of the purchase, is preferably performed on the platform run by the system operator. Alternatively, the step may be performed on a platform of the loyalty program, in which case “calculating” involves receiving the output of the calculation that was performed on the platform of the loyalty program.

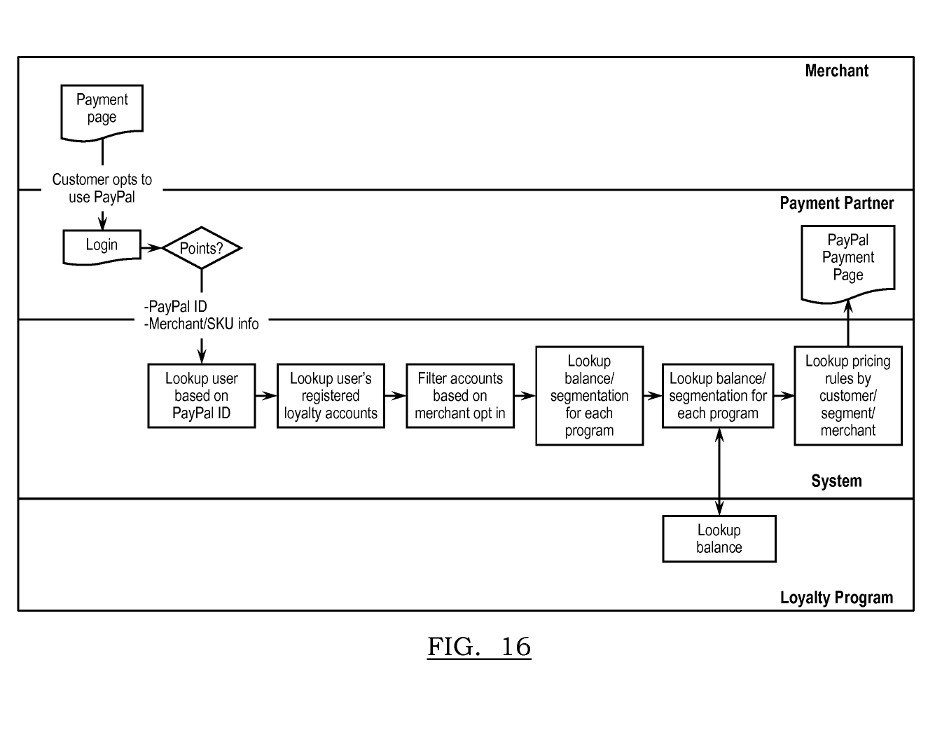

Step S150, which includes querying the at least one loyalty program for a number of loyalty program points in the user's account, functions to determine if the user has an adequate number of points to pay for the purchase. In a preferred embodiment, a query that is sent to the loyalty program for the number of loyalty program points in the user's account is the same query that is sent in order to determine if the user has an account with that loyalty program. As shown in FIG. 16, in a preferred embodiment, the number of loyalty program points is relayed from a database of the loyalty program. Alternatively, a boolean indication of whether or not the user has enough points to pay for the purchase is relayed. For example, a query of American Airlines might return the string “yes” in a packet to indicate that a user has enough loyalty program points to pay for a meal. Alternatively, a replicate database or cache of users is kept on the platform of a system operator, in which case the query is sent to this database or cache. In one embodiment, the system may also return a set of valid “cash and points” options for the transaction, such that the hub widget may facilitate the points portion of the transaction, and the payment provider may facilitate the cash portion of the transaction.

The step S150 of querying the at least one loyalty program for a number of loyalty program points in the user's account preferably forms a connection with the loyalty program. Alternatively, if the system of the loyalty program is malfunctioning, the system may still be reliable in its functionality because it may record a debt owed by that user to the loyalty program. The user may be billed at a later point in time. Alternatively, the system may employ segmentation to achieve full reliability.

Step S160, which includes providing the user with an option to pay with loyalty program points if he or she has enough to pay for the purchase, functions to relay the opportunity to pay with loyalty program points to the user. Providing the user with an option to pay with loyalty program points if he or she has enough to pay for the purchase preferably includes relaying an indication that the user has enough points in their account with a loyalty program to pay for the purchase with loyalty program points. The indication is preferably a simple boolean indication of whether or not the user can pay with loyalty program points. For example, the step of providing may involve sending a packet containing a string variable that is set to “true” if the user does not have enough, and “false” if he or she does not. This indication is preferably interpreted in a system of the partnered vendor and relayed to the user as a message inquiring whether or not the user would like to use their loyalty program points to pay for the purchase.

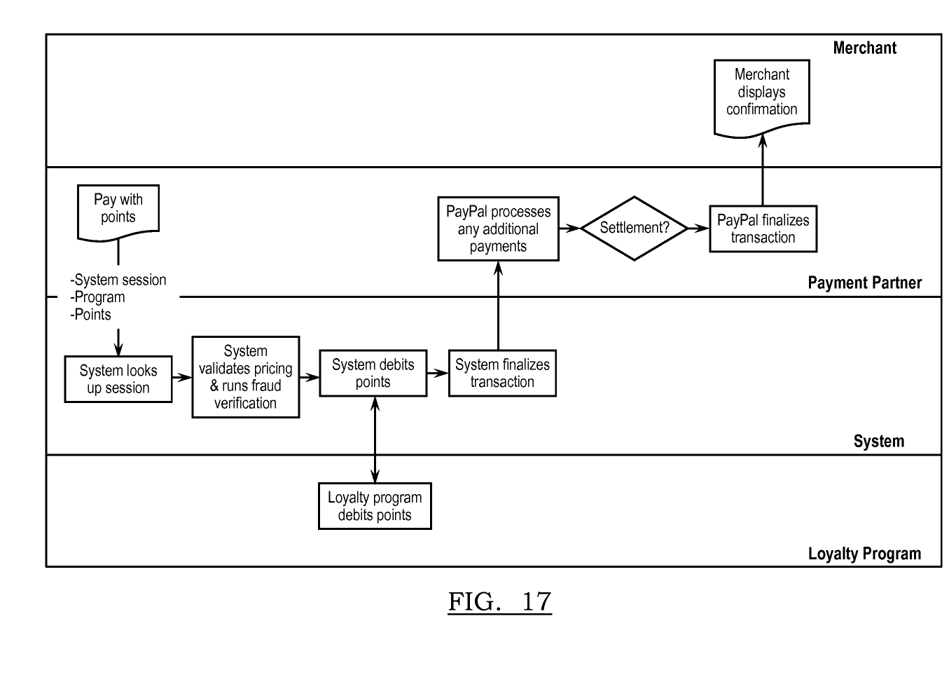

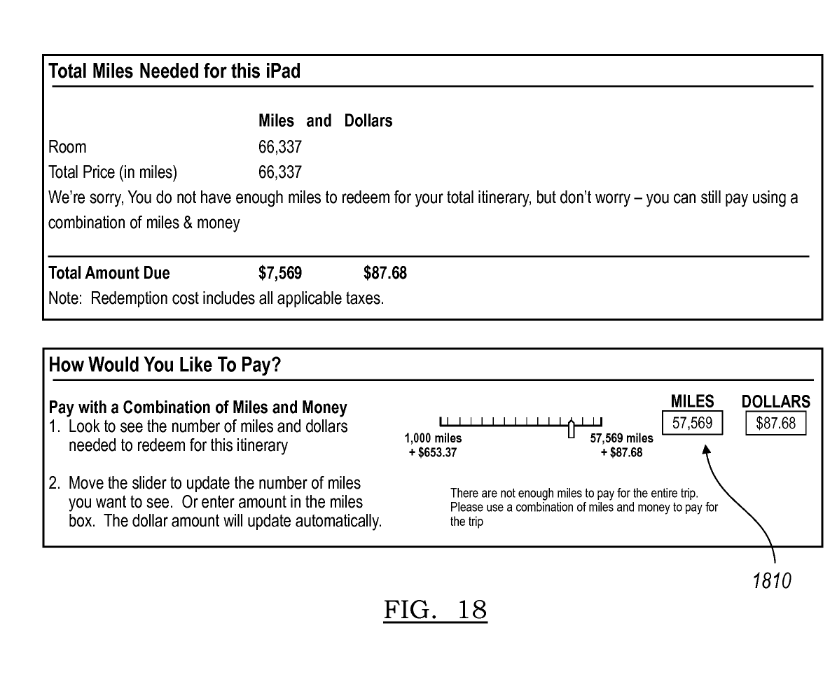

Step S170, which includes debiting, if the user selects the option to pay with loyalty program points, the number of loyalty program points from the user's loyalty program account, functions to enable the user to apply their loyalty program points towards the purchase. As shown in FIG. 17, the debiting of loyalty program points is preferably recorded as a decrement in points in the user's record in the database of the loyalty program. The number of loyalty program points debited is preferably the amount calculated in Step S140. Alternatively, the user may have the option of paying for a fraction of the purchase with loyalty program points, and another fraction of the purchase with cash. The debiting of the number of loyalty program points from the user's loyalty program account may also be completed using the Redeem API as described above in reference to FIG. 4. As shown in FIG. 18, the user may have the option of using a cash-points slider (labeled as component 1810) to signify the fraction of the purchase he or she would like to make with points and the fraction he would like to make with cash. Alternatively, the user may enter in the number of loyalty points they wish to utilize as shown in FIG. 11.

### Systems

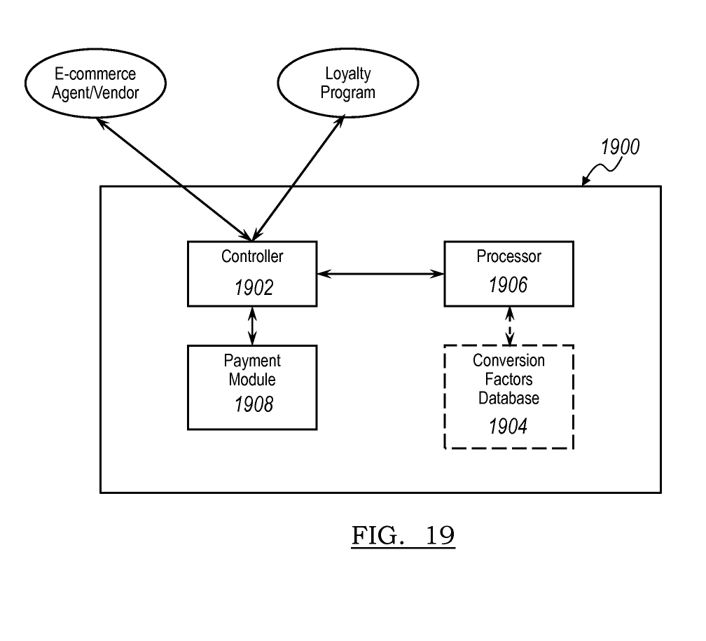

As shown in FIG. 19, a system 1900 for enabling use of loyalty program points as form of payment a preferred embodiment preferably includes a controller 1902, a conversion factor database 1904, a processor 1906, and a payment module 1908. The system preferably functions to enable the use of loyalty program points as a form of payment with a payment partner, or directly with a merchant or vendor. The system preferably implements the methods described herein.

The controller 1902 is preferably configured to receive from an e-commerce agent or vendor a request for a loyalty points price along with a cash price and user identification information, and to receive from a loyalty program a loyalty program points balance and a user customer segment based on the user identification information.

The conversion factor database 1904 is preferably configured to store a plurality of cash-to-points conversion factors that convert between a cash price (i.e., monetary currency) and a loyalty program points price of a product. The pricing factors database 1904 is preferably configured to store various tiers of cash-to-points (and/or points-to-cash) pricing factors. Each factor preferably corresponds to a particular attribute of a product (e.g. cost, product type, brand, availability), a particular customer (e.g. demographic, individual), and/or a particular merchant (e.g., type, location, individual), and/or any suitable categorization. The conversion factors database is preferably stored on a server or other storage device that is accessible by one or more computing devices. In some embodiments, the system 1900 may not include a conversion factor database, as indicated by a dashed line in FIG. 19. For example, the system 1900 may receive the conversion factors directly from a loyalty program.

The processor 1906 is preferably coupled to the controller and to the conversion factor database. The processor 1906 is preferably configured to select from the conversion factor database 1904, a points-to-cash conversion factor based on at least one of the cash price, the user identification information, the loyalty program points balance, and the user customer segment. The processor 1906 is further configured to calculate a loyalty points price based on the points-to-cash conversion factor and the cash price.

The payment module 1908 is preferably coupled to the controller 1902 and is configured to receive confirmation of transaction completion along with a number of loyalty points utilized and to debit from the loyalty program points balance the number of loyalty points utilized in the transaction.

In some embodiments, the methods described herein are implemented in a computer-readable medium storing computer-readable instructions. The instructions are preferably executed by computer-executable components preferably integrated with a centralized hub running the software platform. In an alternative preferred embodiment, a system for enabling use of loyalty program points as form of payment a preferred embodiment preferably includes a software platform that includes a vendor module capable of communicating with one or a set of partnered vendors and/or an e-commerce agents; a loyalty program module capable of communicating with a set of loyalty programs; and a rules engine for calculating amounts of loyalty program points. The software platform may also include logic enabling a connection between a partnered vendor and an e-commerce agent.

The system preferably implements the above methods in a computer-readable medium storing computer-readable instructions. The instructions are preferably executed by computer-executable components. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

### Exemplary Implementations of the System and Method

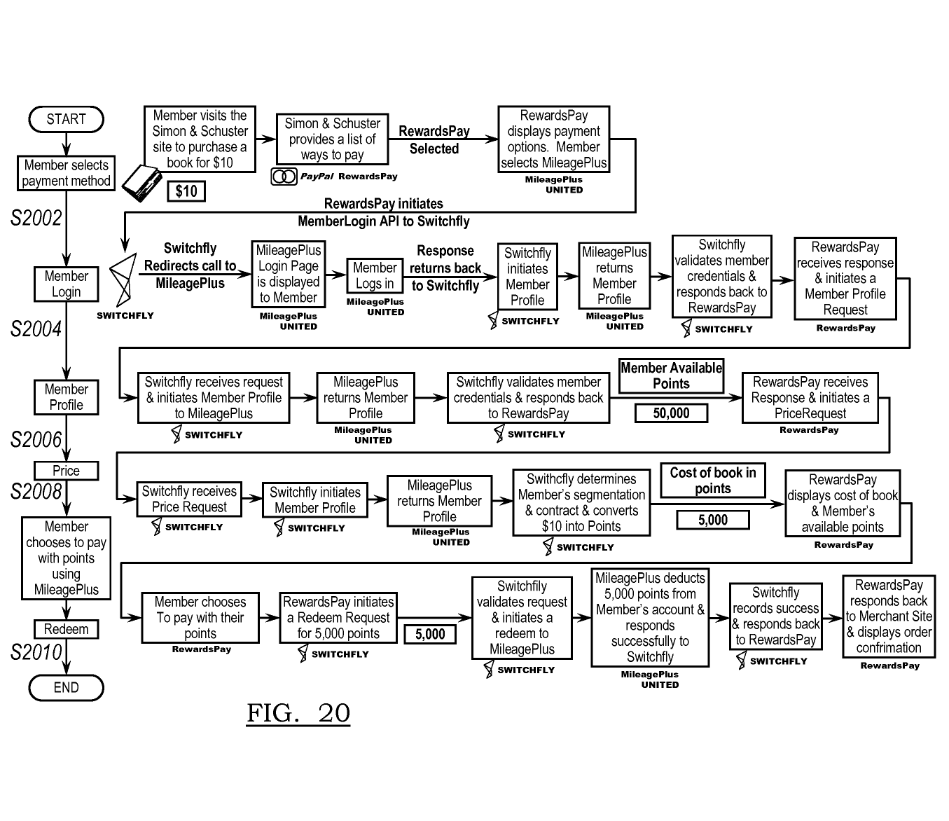

As shown in FIG. 20, an exemplary implementation of the systems and methods described herein may begin with a user selecting loyalty program points as a payment method in block S2002. From there, a user may log into their loyalty program account in block S2004. The user may then receive their loyalty program member account profile information in block S2006 and a loyalty program points price for their purchase in block S2008. Finally the system may initiate the redemption of the loyalty program points from the loyalty program to complete the transaction in block S2010. Any of these steps may be optional and they may be performed in any suitable order.

As shown in FIG. 20, block S2002 may further include the steps of a user visiting a merchant, such as an online bookstore, such as the website of Simon and Schuster in this example; the merchant website (e.g. Simon and Schuster) displaying a list of payment options that are accepted by the merchant; and the user selecting the pay with points payment option (e.g. “RewardsPay” in this example). The method then continues on to block S2004 which functions to log the user into their loyalty program member profile.

Block S2004 may further include the steps of redirecting the user to the loyalty program login page (the loyalty program of Mileage Plus for United Airlines in this example); the user logging into the loyalty program login page; the system initiating a member profile request to receive information about the member profile from the loyalty program; and validating the member credentials. The method then continues on to block S2006 which functions to receive additional information about the member profile from the loyalty program.

Block S2006 may further include the steps of the system initiating a member profile request to receive information about the member profile from the loyalty program and providing this information to the user. For example, the system may display to the user that they have a total of 50,000 points to be used for purchase. The method then continues on to block S2008 which functions to receive and display the loyalty program points price for the user's purchase.

Block S2008 may further include the steps of receiving a price request from the merchant (e.g. the price in points for the $10 cash price); initiating another member profile request by, for example, querying loyalty program (or stored user information) for the member's segmentation and contract; converting the cash price to a points price based on this information (e.g. $10 is converted to 5,000 points); and displaying the points price to the user. If the user confirms that they would like to move forward with the transaction, the method continues onto block S2010.

Block S2010 functions to complete the transaction. Block S2010 may further include the steps of initiating a redeem request for 5,000 points, validating the request and sending the redeem request onto the loyalty program, deducting from the loyalty program 5,000 points from the user's account and confirming this action with the system, and finally confirming with the merchant that the transaction has been completed.

As a person skilled in the art will recognize from the previous detailed description and from the figures and claims, modifications and changes can be made to the preferred embodiments of the invention without departing from the scope of this invention defined in the following claims.

We claim:

1. A method for enabling use of loyalty program points as form of payment, the method comprising the steps of:
receiving through an application programming interface (API), from a first computer associated with an e-commerce agent, a request for a loyalty points price along with a transaction information package comprising a cash price and user identification information;
selecting, from a conversion factor database, a cash-to-points conversion factor based on the transaction information package and a stored user information package comprising a loyalty program points balance and a user customer segment;
calculating with a processor a loyalty points price based on the cash price and the selected cash-to-points conversion factor;
sending, through the API, to the first computer associated with the e-commerce agent, the calculated loyalty points price;
querying a second computer associated with a loyalty program for an updated user information package comprising an updated loyalty program points balance and an updated user customer segment;
selecting, from the conversion factor database, an updated cash-to-points conversion factor based on the transaction information package and the updated user information package;
recalculating an updated loyalty points price based on the cash price and the updated cash-to-points conversion factor;
sending, through the API, to the first computer associated with the e-commerce agent, the updated loyalty points price;
receiving through the API, from the first computer associated with an e-commerce agent, confirmation of transaction completion and a number of loyalty points utilized; and
sending instructions to the second computer associated with the loyalty program to debit from the updated loyalty program points balance the number of loyalty points utilized in the transaction.

2. The method of claim 1, wherein the transaction information package further comprises product information.

3. The method of claim 1, further comprising the step of sending the user identification information to a second computer associated with a loyalty program and requesting user account authentication from the loyalty program.

4. The method of claim 3, wherein the step of sending the user identification information to a loyalty program and requesting user account authentication is performed through a Login Request/Response API.

5. The method of claim 1, wherein the step of querying a loyalty program for an updated user information package is performed just after the step of receiving from an e-commerce agent, a request for a loyalty points price along with a transaction information package comprising a cash price and user identification information.

6. The method of claim 1, wherein the step of querying a loyalty program for an updated user information package is performed just after the step of receiving from an e-commerce agent, confirmation of transaction completion and a number of loyalty points utilized.

7. The method of claim 1, further comprising the step of storing the updated user information package comprising an updated loyalty program points balance and an updated user customer segment in cache as the stored user information package.

8. The method of claim 1, further comprising the step of providing customization to the loyalty program of when the step of querying a loyalty program for an updated user information package is performed, based on their customer preferences.

9. A method for enabling use of loyalty program points as form of payment, the method comprising the steps of:
receiving through an application programming interface (API), from a first computer associated with an e-commerce agent, a request for a loyalty points price along with a transaction information package comprising a cash price and user identification information;
sending the user identification information to a second computer associated with a loyalty program and requesting user account authentication from the loyalty program;
querying the second computer associated with a loyalty program for a user information package comprising a loyalty program points balance, a user customer segment, and a cash-to-points conversion factor;
calculating a loyalty points price based on the cash price and the cash-to-points conversion factor;
sending, through the API, to the first computer associated with the e-commerce agent, the loyalty points price;
receiving through the API, from the first computer associated with an e-commerce agent, confirmation of transaction completion and a number of loyalty points utilized; and
sending instructions to the second computer associated with the loyalty program to debit from the updated loyalty program points balance the number of loyalty points utilized in the transaction.

10. The method of claim 9, wherein the step of receiving a request a request for a loyalty points price along with a transaction information package comprising a cash price and user identification information is performed through a Price Request/Response API.

11. The method of claim 9, wherein the step of calculating a loyalty points price based on the cash price and the cash-to-points conversion factor is performed through a Price Request/Response API.

12. The method of claim 9, wherein the step of sending the loyalty points price to the e-commerce agent is performed through a Price Request/Response API.

13. The method of claim 9, wherein the step of querying a loyalty program for an user information package is performed through a Price Request/Response API.

14. The method of claim 9, wherein the step of querying a loyalty program for an user information package is performed through a Profile Request/Response API.

15. The method of claim 9, wherein the step of receiving from an e-commerce agent confirmation of transaction completion and a number of loyalty points utilized is performed through a Redeem Request/Response API.

16. The method of claim 9, wherein the step of sending instructions to the loyalty program to debit the number of loyalty points utilized in the transaction is performed through a Redeem Request/Response API.

17. A method for enabling use of loyalty program points as form of payment, the method comprising the steps of:
receiving through an application programming interface (API), from a first computer associated with an merchant, a request for a loyalty points price along with a transaction information package comprising a cash price and user identification information;
sending the user identification information to a second computer associated with a loyalty program and requesting user account authentication from the loyalty program;
querying the second computer associated with a loyalty program for a user information package comprising a loyalty program points balance, a user customer segment, and a cash-to-points conversion factor;
calculating a loyalty points price based on the cash price and the cash-to-points conversion factor;
sending, through the API, to the first computer associated with the merchant, the loyalty points price;
receiving through the API, from the first computer associated with an merchant, confirmation of transaction completion and a number of loyalty points utilized; and
sending instructions to the second computer associated with the loyalty program to debit from the updated loyalty program points balance the number of loyalty points utilized in the transaction.

18. The method of claim 17, further comprising the step of sending, through the API, to the first computer associated with the merchant, an authentication key.

19. The method of claim 18, wherein the authentication key maps an incoming request to a given merchant.

20. The method of claim 19, wherein the step of sending an authentication key to the merchant comprises sending multiple user keys to the merchant.
